(19) United States
(12) Patent Application Publication
(10) Pub. No.: US 2026/0197446 A1
(43) Pub. Date: Jul. 9, 2026

(54) APPLICATIONS OF INTRA BLOCK COPY AND INTRA TEMPLATE MATCHING WITH FRACTIONAL-PEL BLOCK VECTOR

(71) Applicant: QUALCOMM Incorporated, San Diego, CA (US)

(72) Inventors: Chun-Chi Chen, San Diego, CA (US); Bappaditya Ray, San Diego, CA (US); Hongtao Wang, San Diego, CA (US); Vadim Seregin, San Diego, CA (US); Marta Karczewicz, San Diego, CA (US)

(21) Appl. No.: 19/556,702

(22) Filed: Mar. 4, 2026

Related U.S. Application Data
(62) Division of application No. 18/437,485, filed on Feb. 9, 2024.
(60) Provisional application No. 63/488,469, filed on Mar. 3, 2023.
(60) Provisional application No. 63/493,169, filed on Mar. 30, 2023.

(51) Int. Cl. H04N 19/11; H04N 19/105; H04N 19/13; H04N 19/157; H04N 19/176; H04N 19/70

(52) U.S. Cl. CPC H04N 19/11; H04N 19/105; H04N 19/13; H04N 19/157; H04N 19/176; H04N 19/70

(57) ABSTRACT

Devices and techniques are disclosed for coding video data. An example device includes one or more memories configured to store the video data and one or more processors coupled to the one or more memories. The one or more processors are configured to determine to code a first block of the video data using intra block copy merge mode with block vector differences (IBC-MBVD). The one or more processors are configured to process a syntax element indicative of whether to use IBC-MBVD with fractional-pel offsets or to use IBC-MBVD with integer-pel offsets. The one or more processors are configured to code the first block based on a determination of whether to use IBC-MBVD with fractional-pel offsets or IBC-MBVD with integer-pel offsets.

This application is a divisional application of U.S. patent application Ser. No. 18/437,485, filed on Feb. 9, 2024, which claims the benefit of U.S. Provisional Patent Application No. 63/488,469, filed Mar. 3, 2023, and U.S. Provisional Patent Application No. 63/493,169, filed Mar. 30, 2023, the entire content of all of which is incorporated by reference.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), ITU-T H.266/Versatile Video Coding (VVC), and extensions of such standards, as well as proprietary video codecs/formats such as AOMedia Video 1 (AV1) that was developed by the Alliance for Open Media. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques for extending intra block copy (IBC) and/or Intra template matching (IntraTMP) to supporting block vectors (BVs) pointing to fractional-pel positions on a reference picture (e.g., the reconstructed area of the current frame). This extension may be desirable as one may want to use IBC and/or IntraTMP to code nature content, but the repetitive patterns occurring in nature content may not always align exactly with grid samples (e.g., integer-pel positions). As such, the techniques of this disclosure may provide for improved quality of encoded video content, such as nature content (e.g., trees, beaches, mountains, etc.).

In one example, a method includes determining to code a first block of the video data using intra block copy merge mode with block vector differences (IBC-MBVD); processing a syntax element indicative of whether to use IBC-MBVD with fractional-pel offsets or to use IBC-MBVD with integer-pel offsets; and coding the first block based on a determination of whether to use IBC-MBVD with fractional-pel offsets or IBC-MBVD with integer-pel offsets.

In another example, a device includes one or more memories configured to store video data and one or more processors implemented in circuitry and coupled to the one or more memories, the one or more processors being configured to: determine to code a first block of the video data using intra block copy merge mode with block vector differences (IBC-MBVD); process a syntax element indicative of whether to use IBC-MBVD with fractional-pel offsets or to use IBC-MBVD with integer-pel offsets; and code the first block based on a determination of whether to use IBC-MBVD with fractional-pel offsets or IBC-MBVD with integer-pel offsets.

In another example, a device includes means for determining to code a first block of the video data using intra block copy merge mode with block vector differences (IBC-MBVD); means for determining to code the first block using IBC-MBVD with fractional-pel offsets; and means for coding the first block based on the fractional-pel offsets based on determining to code the first block using IBC-MBVD with fractional-pel offsets.

In another example, computer-readable storage media is encoded with instructions that, when executed, cause a programmable processor to determine to code a first block of video data using intra block copy merge mode with block vector differences (IBC-MBVD); process a syntax element indicative of whether to use IBC-MBVD with fractional-pel offsets or to use IBC-MBVD with integer-pel offsets; and code the first block based on a determination of whether to use IBC-MBVD with fractional-pel offsets or IBC-MBVD with integer-pel offsets.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIG. 2 is a conceptual diagram illustrating an example of IBC.

FIG. 3 is a conceptual diagram illustrating an example of template matching on a search area around an initial motion vector.

FIG. 4 is a conceptual diagram of an example intra template matching search area.

FIG. 5 is a conceptual diagram illustrating example IBC reference regions depending on a current CU position.

FIG. 6A is a conceptual diagram illustrating five example locations in reconstructed luma samples.

FIG. 6B is a conceptual diagram illustrating an example prediction process of DBV techniques.

FIG. 7 is a conceptual diagram illustrating an example of AMVP IBC candidate clustering based on the L2 distance and the TM cost.

FIG. 8 is a conceptual diagram illustrating example neighboring pixels used to estimate parameters in an IC model.

FIG. 9 is a conceptual diagram illustrating example neighboring samples used for deriving IC parameters.

FIG. 10 is a block diagram illustrating an example architecture of luma mapping with chroma scaling.

FIG. 11 is a conceptual diagram illustrating an example template.

FIG. 12 is a conceptual diagram illustrating an example of a valid search range of IBC or IntraTMP according to the techniques of this disclosure.

FIGS. 13A-B are conceptual diagrams illustrating an example of horizontal padding according to the techniques of this disclosure.

FIGS. 14A-B are conceptual diagrams illustrating an example of vertical padding according to the techniques of this disclosure.

FIGS. 15A-B are conceptual diagrams illustrating an example of horizontal padding according to the techniques of this disclosure.

FIGS. 16A-B are conceptual diagrams illustrating an example of vertical padding according to the techniques of this disclosure.

FIGS. 17A-B are conceptual diagrams illustrating an example of unconditional padding for the horizontal direction according to the techniques of this disclosure.

FIGS. 18A-B are conceptual diagrams illustrating an example of unconditional padding of the vertical direction according to the techniques of this disclosure.

FIG. 19 is a flowchart illustrating an example method for coding a block of video data using intra block copy (IBC) merge mode with block vector differences (MBVD).

FIG. 20 is a block diagram illustrating an example video encoder that may perform the techniques of this disclosure.

FIG. 21 is a block diagram illustrating an example video decoder that may perform the techniques of this disclosure.

FIG. 22 is a flowchart illustrating an example method for encoding a current block in accordance with the techniques of this disclosure.

FIG. 23 is a flowchart illustrating an example method for decoding a current block in accordance with the techniques of this disclosure.

### DETAILED DESCRIPTION

IBC was generally considered as a specialized coding tool for screen content. Because screen content is usually rendered at integer grid with sharp signals, IBC generally works with integer-pel block vector precision (or higher, such as, 4-pel block vector precision). However, when IBC is used in coding of nature content, the limitation imposed on BVs to support only integer-pel precision has become a major performance bottleneck on IBC, because repetitive patterns may not always sit exactly on grid samples. Thus, it may be desirable to extend IBC (and IntraTMP) to supporting BV's pointing to fractional-pel positions on a reference picture (e.g., the reconstructed area of the current frame). By providing fractional-pel support to IBC and/or IntraTMP, the techniques of this disclosure may provide for improved quality of encoded video content, such as nature content.

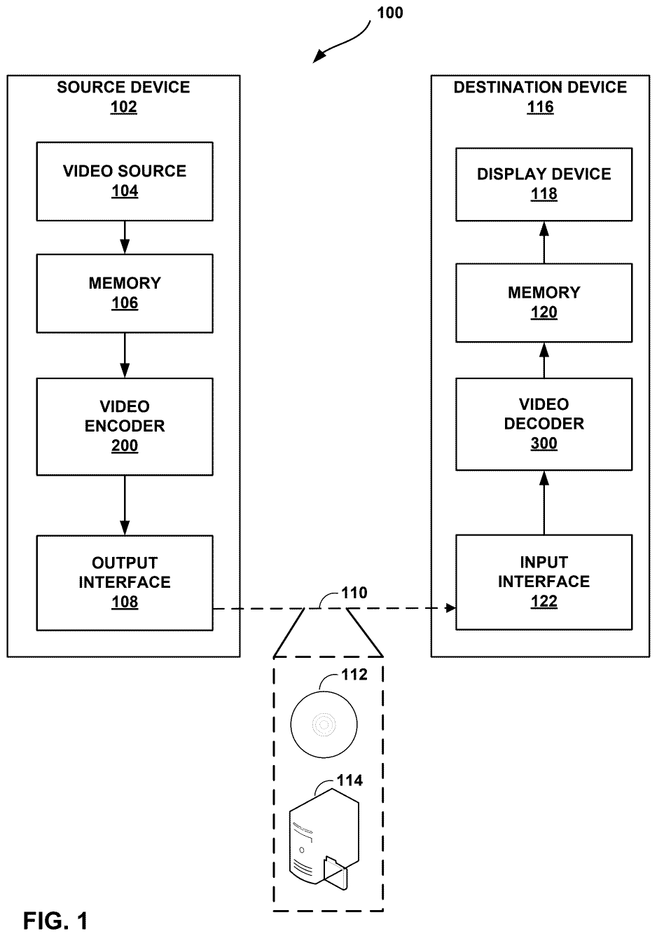

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, unencoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may be or include any of a wide range of devices, such as desktop computers, notebook (i.e., laptop) computers, mobile devices, tablet computers, set-top boxes, telephone handsets such as smartphones, televisions, cameras, display devices, digital media players, video gaming consoles, video streaming device, broadcast receiver devices, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for Intra Block Copy (IBC) and Intra Template Matching (IntraTMP) with the support of fractional-pel block vectors. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding and/or decoding device may perform techniques for IBC and IntraTMP with the support of fractional-pel block vectors. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, unencoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may include any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video data generated by source device 102. Destination device 116 may access stored video data from file server 114 via streaming or download.

File server 114 may be any type of server device capable of storing encoded video data and transmitting that encoded video data to the destination device 116. File server 114 may represent a web server (e.g., for a website), a server configured to provide a file transfer protocol service (such as File Transfer Protocol (FTP) or File Delivery over Unidirectional Transport (FLUTE) protocol), a content delivery network (CDN) device, a hypertext transfer protocol (HTTP) server, a Multimedia Broadcast Multicast Service (MBMS) or Enhanced MBMS (eMBMS) server, and/or a network attached storage (NAS) device. File server 114 may, additionally or alternatively, implement one or more HTTP streaming protocols, such as Dynamic Adaptive Streaming over HTTP (DASH), HTTP Live Streaming (HLS), Real Time Streaming Protocol (RTSP), HTTP Dynamic Streaming, or the like.

Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. Input interface 122 may be configured to operate according to any one or more of the various protocols discussed above for retrieving or receiving media data from file server 114, or other such protocols for retrieving media data.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 include wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 includes a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder, and may include appropriate MUX-DEMUX units, or other hardware and/or software, to handle multiplexed streams including both audio and video in a common data stream.

Video encoder 200 and video decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may implement video encoder 200 and/or video decoder 300 in processing circuitry such as an integrated circuit and/or a microprocessor. Such a device may be a wireless communication device, such as a cellular telephone, or any other type of device described herein.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC). In other examples, video encoder 200 and video decoder 300 may operate according to a proprietary video codec/format, such as AOMedia Video 1 (AV1), extensions of AV1, and/or successor versions of AV1 (e.g., AV2). In other examples, video encoder 200 and video decoder 300 may operate according to other proprietary formats or industry standards. The techniques of this disclosure, however, are not limited to any particular coding standard or format. In general, video encoder 200 and video decoder 300 may be configured to perform the techniques of this disclosure in conjunction with any video coding techniques that use IBC and/or IntraTMP with the support of fractional-pel block vectors.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of CTUs. Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to CUs.

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

When operating according to the AV1 codec, video encoder 200 and video decoder 300 may be configured to code video data in blocks. In AV1, the largest coding block that can be processed is called a superblock. In AV1, a superblock can be either 128×128 luma samples or 64×64 luma samples. However, in successor video coding formats (e.g., AV2), a superblock may be defined by different (e.g., larger) luma sample sizes. In some examples, a superblock is the top level of a block quadtree. Video encoder 200 may further partition a superblock into smaller coding blocks. Video encoder 200 may partition a superblock and other coding blocks into smaller blocks using square or non-square partitioning. Non-square blocks may include N/2×N, N×N/2, N/4×N, and N×N/4 blocks. Video encoder 200 and video decoder 300 may perform separate prediction and transform processes on each of the coding blocks.

AV1 also defines a tile of video data. A tile is a rectangular array of superblocks that may be coded independently of other tiles. That is, video encoder 200 and video decoder 300 may encode and decode, respectively, coding blocks within a tile without using video data from other tiles. However, video encoder 200 and video decoder 300 may perform filtering across tile boundaries. Tiles may be uniform or non-uniform in size. Tile-based coding may enable parallel processing and/or multi-threading for encoder and decoder implementations.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning, QTBT partitioning, MTT partitioning, superblock partitioning, or other partitioning structures.

In some examples, a CTU includes a coding tree block (CTB) of luma samples, two corresponding CTBs of chroma samples of a picture that has three sample arrays, or a CTB of samples of a monochrome picture or a picture that is coded using three separate color planes and syntax structures used to code the samples. A CTB may be an N×N block of samples for some value of N such that the division of a component into CTBs is a partitioning. A component is an array or single sample from one of the three arrays (luma and two chroma) that compose a picture in 4:2:0, 4:2:2, or 4:4:4 color format or the array or a single sample of the array that compose a picture in monochrome format. In some examples, a coding block is an M×N block of samples for some values of M and N such that a division of a CTB into coding blocks is a partitioning.

The blocks (e.g., CTUs or CUS) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile. The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may include N×M samples, where Mis not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

AV1 includes two general techniques for encoding and decoding a coding block of video data. The two general techniques are intra prediction (e.g., intra frame prediction or spatial prediction) and inter prediction (e.g., inter frame prediction or temporal prediction). In the context of AV1, when predicting blocks of a current frame of video data using an intra prediction mode, video encoder 200 and video decoder 300 do not use video data from other frames of video data. For most intra prediction modes, video encoder 200 encodes blocks of a current frame based on the difference between sample values in the current block and predicted values generated from reference samples in the same frame. Video encoder 200 determines predicted values generated from the reference samples based on the intra prediction mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

In accordance with the techniques of this disclosure, a method may include determining to code a first block of the video data using intra block copy merge mode with block vector differences (IBC-MBVD); processing a syntax element indicative of whether to use IBC-MBVD with fractional-pel offsets or to use IBC-MBVD with integer-pel offsets; and coding the first block based on a determination of whether to use IBC-MBVD with fractional-pel offsets or IBC-MBVD with integer-pel offsets.

In accordance with the techniques of this disclosure, a method may include determining to apply at least one of intra block copy (IBC) or intra template matching (IntraTMP); applying the at least one of IBC or IntraTMP; determining a minimal area of reference samples; determining a fraction-pel block vector (BV) to be valid based on all reference samples being within a valid search range of the at least one of IBC or IntraTMP; and coding the video data based on the application of the at least one of IBC or IntraTMP.

This disclosure describes applications of the Intra Block Copy (IBC) and Intra Template Matching (IntraTMP) techniques with the support of fractional-pel block vectors. The disclosed techniques can be applied to any existing video codecs, such as HEVC (High Efficiency Video Coding), VVC (Versatile Video Coding), Essential Video Coding (EVC) codecs, or be a coding feature in future video coding standards (e.g., ECM (Enhanced Compression Model)). In this section, HEVC, VVC and works in ECM related to such techniques are reviewed.

Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multi-view Video Coding (MVC) extensions.

In addition, a new video coding standard, namely High Efficiency Video Coding (HEVC) or ITU-T H.265, including its range extension, multiview extension (MV-HEVC) and scalable extension (SHVC), has recently been developed by the Joint Collaboration Team on Video Coding (JCT-VC) as well as Joint Collaboration Team on 3D Video Coding Extension Development (JCT-3V) of ITU-T Video Coding Experts Group (VCEG) and ISO/IEC Motion Picture Experts Group (MPEG).

The latest HEVC draft specification, and referred to as HEVC WD hereinafter, is available from http://phenix.int-vry.fr/jct/doc_end_user/documents/14_Vienna/wg11/JCTVC-N1003-v1

ITU-T VCEG (Q6/16) and ISO/IEC MPEG (JTC 1/SC 29/WG 11) are studying the potential need for standardization of future video coding technology with a compression capability that significantly exceeds that of the current HEVC standard (including its current extensions and near-term extensions for screen content coding and high-dynamic-range coding). These groups are working together on this exploration activity in a joint collaboration effort known as the Joint Video Exploration Team (JVET) to evaluate compression technology designs proposed by their experts in this area. The latest version of reference software, i.e., VVC Test Model 19 (VTM-19.0) could be downloaded from: https://vcgit.hhi.fraunhofer.de/jvet/VVCSoftware_VTM

The Versatile Video Coding (VVC) draft specification may be referred to as JVET-T2001. An algorithm description of Versatile Video Coding and Test Model 10 (VTM 10.0) may be referred to as JVET-T2002. An algorithm description of Enhanced Compression Model 7 (ECM-7.0) may be referred to as JVET-AB2025.

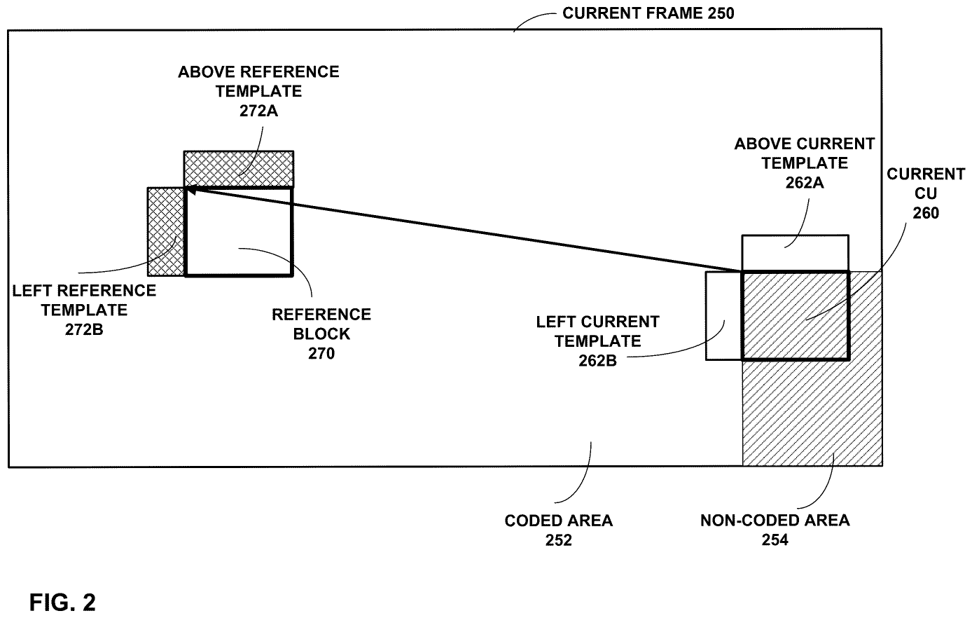

FIG. 2 is a conceptual diagram illustrating an example of Intra Block Copy (IBC). IBC is one of the coding tools for screen content. For a current coding unit (CU) 260, a video codec such as video encoder 200 or video decoder 300 using IBC will search a plurality of block vectors and find the best matching block in the reference region for prediction as shown in FIG. 2. Then, a prediction of the chosen block vector is generated and the difference between the chosen block vector and the predicted block vector, known as block vector difference (BVD), is signaled in the bitstream. For example, video encoder 200 may generate the chosen block vector and the BVD and signal the BVD in the bitstream to video decoder 300.

Template matching (TM) is a decoder-side MV derivation technique to refine the motion information of the current CU by finding the closest match between a template (e.g., top and/or left neighboring blocks of the current CU such as above current template 262A and left current template 262B) in the current picture and template (e.g., above reference template 272A and/or left reference template 272B) of a block (e.g., reference block 270) in a reference picture. For example, a closest match may be a closes size match. TM may be applied to both AMVP and regular merge mode, called respectively, TM-AMVP and TM-MRG modes. Similarly, the same TM techniques may also be applied to IBC AMVP and IBC Merge mode. The only difference between Inter TM and IBC TM is that the reference picture for IBC TM is the reconstructed area (coded area 252) in the current frame (current frame 250). As such, the reference block for current CU 260 with IBC TM may be a reference block within coded area 252 (as opposed to non-coded area 254), such as reference block 270. Without loss of generality, this disclosure generally uses “MV” or “motion” to represent that a current CU is an Inter block and has motion information or that the current CU is an IBC block and has block vector information.

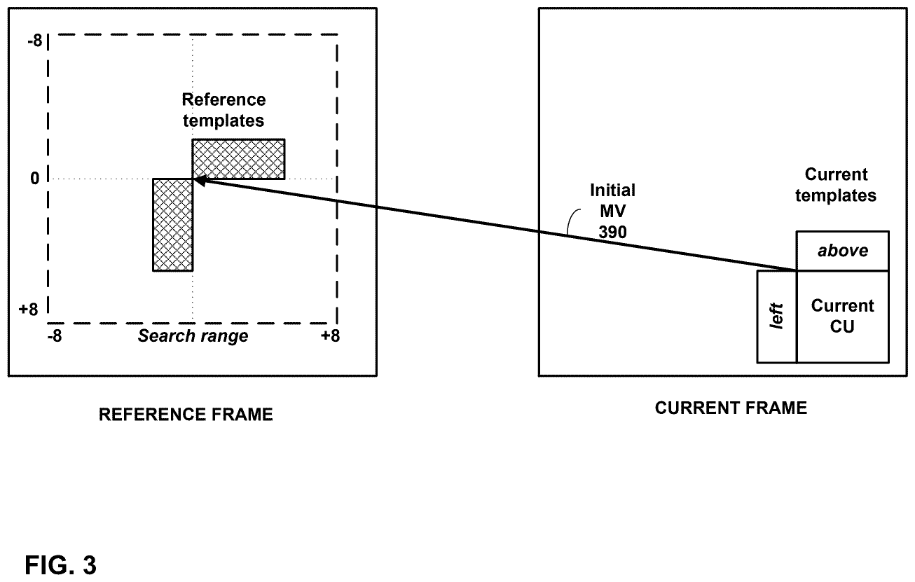

FIG. 3 is a conceptual diagram illustrating an example of template matching on a search area around an initial motion vector. As illustrated in the FIG. 3, a better MV than initial MV 390 is searched around initial MV 390 of the current CU within a [−8, +8]-pel search range. For example, video encoder 200 or video decoder 300 may perform such a search. The template matching techniques in Chen, et al. “Description of SDR, HDR and 360° video coding technology proposal by Qualcomm and Technicolor-low and high complexity versions,” Joint Video Experts Team (JVET) of ITU-T SG 16 WP 3 and ISO/IEC JTC 1/SC 29/WG 11, 10th Meeting: San Diego, 10-20 Apr. 2018, JVET-J0021, may be used with the following modifications: the search step size may be determined based on AMVR mode and TM can be cascaded with a bilateral matching process in merge modes.

Video encoder 200 or video decoder 300 may operate in TM-AMVP mode. In TM-AMVP mode, an MVP candidate is determined based on template matching error to select the one which reaches the minimum difference between the current block template and the reference block template, and then TM may be performed only for this particular MVP candidate for MV refinement. TM may refine this MVP candidate, starting from full-pel MVD precision (or 4-pel for 4-pel AMVR mode) within a [−8, +8]-pel search range by using an iterative diamond search. The AMVP candidate may be further refined by using a cross search with full-pel MVD precision (or 4-pel for 4-pel AMVR mode), followed sequentially by half-pel and quarter-pel cross searches depending on AMVR mode as specified in TABLE 1 below. This search process may ensure that the MVP candidate retains the same MV precision as indicated by the AMVR mode after a TM process. In the search process, if the difference between the previous minimum cost and the current minimum cost in an iteration is less than a threshold that is equal to the area of the block, the search process may terminate.

TABLE 1
SEARCH PATTERNS OF AMVR
AND MERGE MODE WITH AMVR

| | AMVR mode | | | | | |
|---|---|---|---|---|---|---|
| Search | 4- | Full- | Half- | Quarter- | Merge mode | |
| pattern | pel | pel | pel | pel | AltIF = 0 | AltIF = 1 |
| 4-pel | v | | | | | |
| diamond | | | | | | |
| 4-pel cross | v | | | | | |
| Full-pel | | v | v | v | v | v |
| diamond | | | | | | |
| Full-pel | | v | v | v | v | v |
| cross | | | | | | |
| Half-pel | | | v | v | v | v |
| cross | | | | | | |
| Quarter- | | | | v | v | |
| pel cross | | | | | | |
| ⅛-pel | | | | | v | |
| cross | | | | | | |

In TM-MRG merge mode, similar search techniques are applied to the merge candidate indicated by the merge index. Video encoder 200 or video decoder 300 may operate in TM-MRG merge mode. As Table 1 shows, TM may perform all the way down to 1/8-pel MVD precision or skipping those beyond half-pel MVD precision, depending on whether the alternative interpolation filter (that is used when AMVR is of half-pel mode) is used according to merged motion information. Besides, when TM mode is enabled, template matching may work as an independent process or an extra MV refinement process between block-based and subblock-based bilateral matching (BM) methods, depending on whether BM can be enabled or not according to its enabling condition check.

Intra template matching prediction (IntraTMP) is a special intra prediction mode that in which video encoder 200 or video decoder 300 copies the best prediction block from the reconstructed part of the current frame, whose L-shaped template matches the current template. For a predefined search range, video encoder 200 searches for the most similar template to the current template in a reconstructed part of the current frame and uses the corresponding block as a prediction block. Video encoder 200 then signals the usage of this mode, and the same prediction operation is performed by video decoder 300.

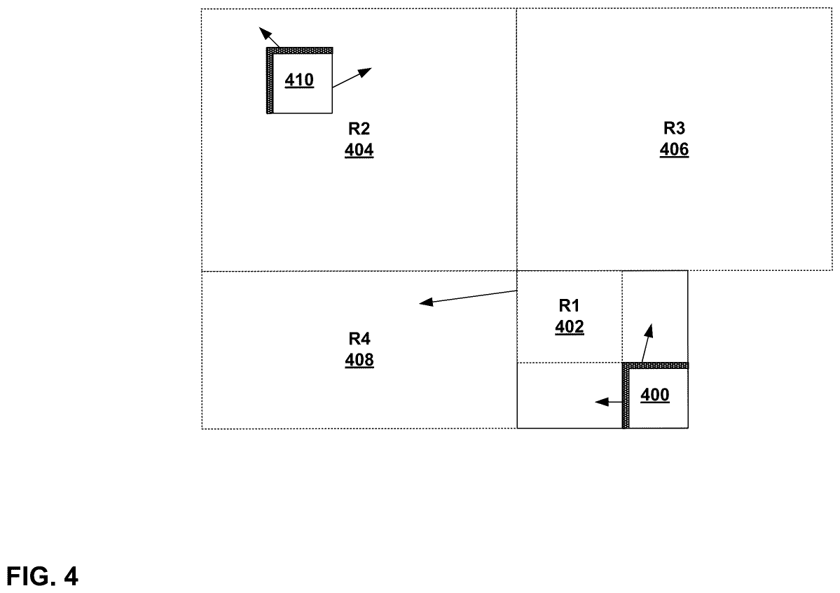

FIG. 4 is a conceptual diagram of an example intra template matching search area. Video encoder 200 or video decoder 300 may generate a prediction signal. The prediction signal is generated by matching the L-shaped causal neighbor of a current block 400 with another block in a predefined search area in FIG. 4 including R1 402 (the current CTU), R2 404 (the top-left CTU), R3 406 (the above CTU), and R4 408 (the left CTU). SAD may be used as a cost function. Within each region (R1 402, R2 404, R3 406, and R4 408), for example, video decoder 300 searches for the template that has least SAD with respect to the template of current block 400 and uses the corresponding block of the template having the least SAD with respect to the template of current block 400 as a prediction block. For example, video decoder 300 may determine that matching block 410 is the prediction block for current block 400.

The dimensions of all regions (SearchRange_w, SearchRange_h) may be set proportional to the block dimension (BlkW, BlkH) to have a fixed number of SAD comparisons per pixel. That is:

$$SearchRange\_w = 5 * BlkW$$

$$SearchRange\_h = 5 * BlkH$$

The intra template matching tool may be enabled for CUs with size less than or equal to 64 in width and height. This maximum CU size for intra template matching may be configurable. The intra template matching prediction mode is signaled at a CU level through a dedicated flag when decoder-side intra mode derivation (DIMD) is not used for the current CU.

Template Matching may be used in IBC for both IBC merge mode and IBC AMVP mode, called respectively as IBC-TM-AMVP and IBC-TM-MRG. Video encoder 200 or video decoder 300 may use such modes.

In IBC-TM-MRG, the merge list is modified compared to the one used by regular IBC merge mode such that the candidates are selected according to a pruning method with a motion distance between the candidates as in the regular TM merge mode. The ending zero motion fulfillment is replaced by motion vectors to the left (−W, 0), top (0, −H) and top-left (−W, −H), where W is the width and H the height of the current CU. In addition, the selected candidates are refined with the Template Matching techniques prior to the RDO or decoding process. The IBC-TM-MRG mode has been put in competition with the regular IBC merge mode and a TM-merge flag is signaled.

In the IBC-TM-AMVP mode, up to 3 candidates are selected from the IBC-TM-MRG merge list. Each of those 3 selected candidates are refined using the Template Matching techniques and sorted according to their resulting Template Matching cost. Only the first 2 candidates are then considered in the motion estimation process.

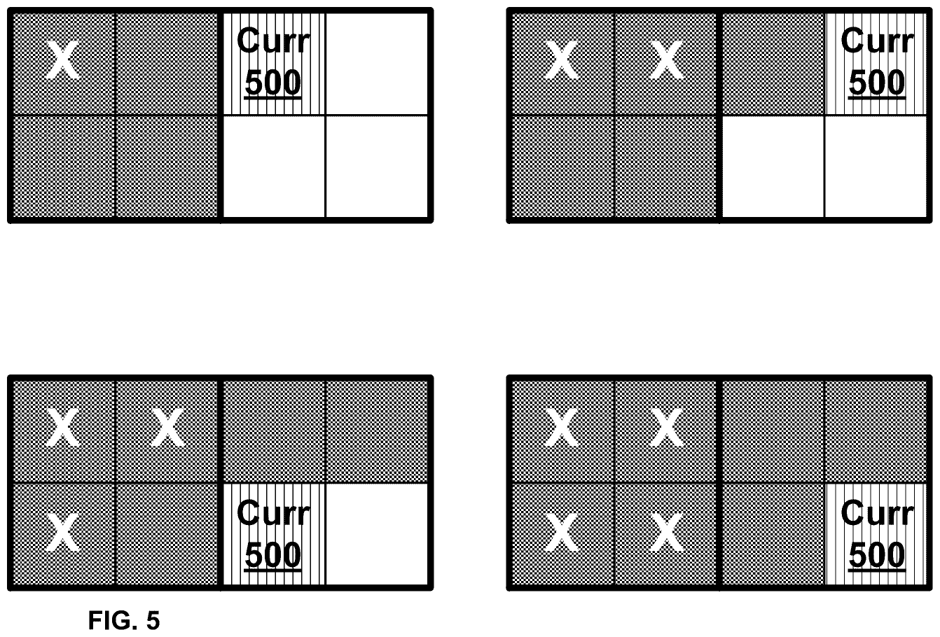

FIG. 5 is a conceptual diagram illustrating example IBC reference regions depending on a current CU position. The Template Matching refinement for both IBC-TM merge and AMVP modes is quite simple since IBC motion vectors are constrained (i) to be integer and (ii) within a reference region as shown FIG. 5. Specifically, in the example of FIG. 5, each small square corresponds to a CU. The squares with darker borders surrounding groups of four CUs may correspond to CTUs. In some examples, each of the CTUs may be of size 128×128 while each of the CUs may have sizes of 64×64. Furthermore, FIG. 5 show a current CU 500 at different locations within a CTU. Shaded CUs are causal for current CU 500. Different CUs are available for IBC depending on the position of current CU 500. In FIG. 5, CUs marked with “X” are unavailable for IBC.

In IBC-TM-MRG mode, all refinements are performed at integer precision, and in IBC-TM-AMVP mode, all refinements are performed either at integer or 4-pel precision depending on the AMVR value. Such a refinement accesses only samples without interpolation. In both cases, the refined motion vectors and the used template in each refinement step must respect the constraint of the reference region.

An IBC-TM-MRG coded block does not inherit flip type from a RR-IBC coded neighbor block.

An IBC-TM-AMVP coded block can also be a RR-IBC coded block with a horizontal or vertical flip type, and template matching does not apply in such a case.

IBC merge mode with block vector differences (IBC-MBVD) for intra prediction is now discussed. Affine-MMVD and GPM-MMVD have been adopted to ECM as an extension of regular MMVD mode. It is natural to extend the MMVD mode to the IBC merge mode.

In IBC-MBVD, the distance set is {1-pel, 2-pel, 4-pel, 8-pel, 12-pel, 16-pel, 24-pel, 32-pel, 40-pel, 48-pel, 56-pel, 64-pel, 72-pel, 80-pel, 88-pel, 96-pel, 104-pel, 112-pel, 120-pel, 128-pel}, and the BVD directions are two horizontal and two vertical directions.

The base candidates are selected from the first five candidates in the reordered IBC merge list. For example, video encoder 200 or video decoder 300 may select such candidates. Based on the SAD cost between the template (one row above and one column left to the current block) and its reference for each refinement position, all the possible MBVD refinement positions (20×4) for each base candidate are reordered. Finally, the top 8 refinement positions with the lowest template SAD costs are kept as available positions, consequently for MBVD index coding. The MBVD index is binarized by the rice code with the parameter equal to 1.

An IBC-MBVD coded block does not inherit flip type from a RR-IBC coded neighbor block.

The direct block vector mode for chroma prediction, also called as direct block vector (DBV), is a chroma prediction tool to improve the coding efficiency for chroma components when dual tree is activated in intra slice.

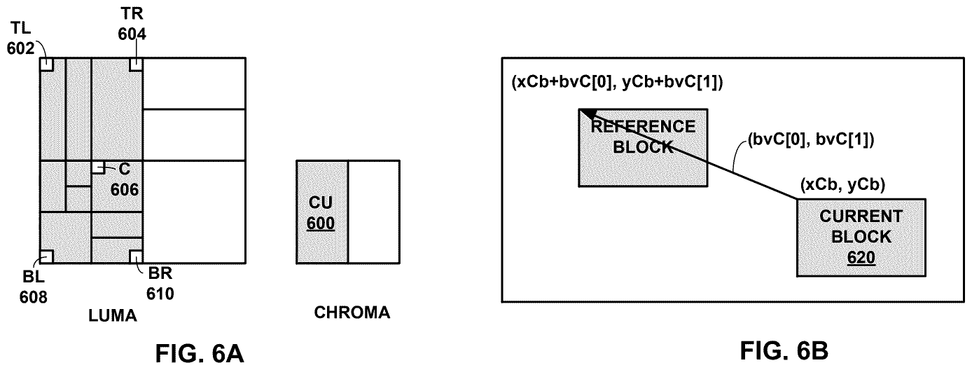

FIG. 6A is a conceptual diagram illustrating five example locations in reconstructed luma samples. FIG. 6B is a conceptual diagram illustrating an example prediction process of DBV techniques.

When chroma dual tree is activated in an intra slice, for a chroma CU 600 coded with DBV mode, if one of the luma blocks in five locations, top left 602, top right 604, center 606, bottom left 608, or bottom right 610, is coded with IBC mode or IntraTmp mode, the luma block vector bvL is used to derive chroma block vector bvC. The BV scaling process is determined according to template matching. If the luma block is coded with a RRIBC, a flip-aware BV adjustment is conducted for bvL.

Then, as depicted in FIG. 6B, by using the position of current chroma block 620 (xCb, yCb) and its bvC, the corresponding offset position (xCb+bvC[0], yCb+bvC[1]) is determined, and a block copy prediction is performed.

A bin is signaled to indicate whether the CU is coded as DBV mode or not, as listed in table 2 below. For example, video encoder 200 may signal the bin to video decoder 300.

TABLE 2
THE BINARIZATION PROCESS FOR
INTRA_CHROMA_PRED_MODE

| intra_chroma_pred_mode | bin string | chroma intra mode |
|---|---|---|
| 0 | 11100 | list[0] |
| 1 | 11101 | list[1] |
| 2 | 11110 | list[2] |
| 3 | 11111 | list[3] |
| 4 | 110 | DIMD chroma |
| 5 | 10 | DM |
| 6 | 0 | DBV |

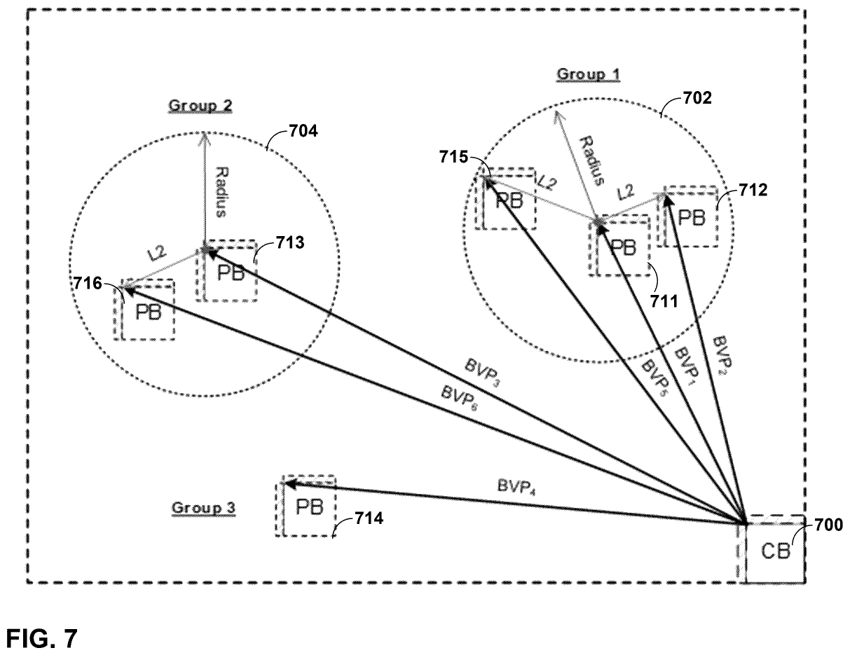

Block vector predictor (BVP) candidate clustering and BVD sign derivation for reconstruction-reordered IBC mode is now discussed. FIG. 7 is a conceptual diagram illustrating an example of AMVP IBC candidate clustering based on the L2 distance and the TM cost.

The IBC AMVP list construction may be modified based on a clustering of the BVP candidates according to the distance between BVP candidates, and the sign prediction of the BVD if the BV has one null component.

For the blocks whose BV has both non-null components, a clustering of the BVP candidates before selecting the two AMVP candidates may be applied. For example, video encoder 200 or video decoder 300 may cluster the BVP candidates. The clustering is used if the number of valid BVP candidates exceeds two, and up to six BVP candidates are clustered based on the L2 Euclidean distance between them. The radius (R) determines a group of vectors as a logarithmic function of the width (cbWidth) and height (cbHeight) of the current block as follows:

$$R = {log}_{2} ( ( cbWidth \cdot cbHeight ) >> MIN\_PU\_SIZE ) \qquad ( 1 )$$

For example, video encoder 200 or video decoder 300 may cluster BVP candidates as show in FIG. 7. Current block 700 is shown with BVPs to various prediction blocks grouped into three clusters. First cluster 702 includes prediction block 711 which is associated with BVP₁, prediction block 712 which is associated with BVP₂, and prediction block 715 which is associated with BVP₅. Second cluster includes prediction block 713 which is associated with BVP₃ and prediction block 716 which is associated with BVP₆. A third cluster consists solely of prediction block 714 which is associated with BVP₄.

For example, the L2 Euclidean distance between prediction block 711 and each of prediction blocks 712 and 715 may be within the radius R defined above. As such prediction blocks 711, 712 and 715 may form first cluster 702. Similarly, the L2 Euclidean distance between prediction block 713 and 716 may be within the radius R defined above. As such prediction blocks 713 and 716 may form second cluster 704. The L2 Euclidean distance between prediction block 714 and each of the other prediction blocks in FIG. 7 may be greater than the radius R. As such, prediction block 714 may form its own cluster.

The clustering techniques are applied in the candidate list order, and the candidates assigned to a group are removed from the list for the subsequent clusters. In each group, the BVP with a lowest TM cost is selected as the representative candidate of that group. The representative candidates of the two first groups are chosen for the motion estimation process as in the regular IBC AMVP list.

On the contrary, BVs with one null component, including the RRIBC blocks, are signaled to video decoder 300 by a bvOneNullComp flag. Instead of invoking the AMVP IBC list construction, two new BVP candidates are determined, which are adjusted to the boundaries of the valid IBC search region according to the horizontal or vertical direction indicated by a bvNullCompDir flag.

The AMVP BVP₀ is set to the nearest valid location to the current block (−cbWidth or −cbHeight), so the BVD, if not null, is always negative, pointing to the left for a BV with a null vertical component or to the above for a BV with a null horizontal component. Likewise, the AMVP BVP₁ is set to the farthest position from the current block in the valid reference region, that is the left boundary or the top boundary of the IBC search region. Consequently, if the BVP₁ is selected, the BVD always is positive, pointing to the right for a BV with a null vertical component or to the bottom for a BV with a null horizontal component.

Video encoder 200 may signal the optimal IBC AMVP index, which allows deriving the sign of the non-null BVD component by video decoder 300. Consequently, the absolute value of the non-null component of the BVD is signaled to video decoder 300, improving the coding efficiency. The RRIBC mode is signaled using the existing syntax flag, and the direction of the flipping mode is derived from the bvNullCompDir flag.

Block vector difference prediction for IBC blocks is now discussed. These techniques are to apply sign prediction to BVD and further extend this approach for predicting suffix bins of BVD magnitudes. Suffix bins are also derived at by video decoder 300 by comparing values of signaled bins with the bins of the best candidates obtained with template matching. The maximum number of bins to be predicted for a PU is set as follow:
Up to 2 BVD signs and 4 BVD suffix bins.

The most significant bins (MSB) of magnitude suffixes of BVD horizontal and vertical components are predicted, and the prediction match result is coded in the bitstream using CABAC context mode. There are 2 context modelers used to code the first N MSB bins, e.g., N=5 for integer-pel AMVR mode and N=3 for four-pel AMVR mode, and there are 4 context modelers are used to code the rest of MSB bins. The less significant bins of magnitude suffixes of horizontal and vertical BVD components are coded in by-pass mode.

Local illumination compensation is now described. In JCTVC-C041, a partition-based illumination compensation (PBIC) was proposed for HEVC. Different from weighted prediction (WP) which is indicated and includes signaling of parameters at a slice level, PBIC is enabled/disabled and signals its model parameters at PU level to handle local illumination variation.

Similar to WP, illumination compensation also has a scaling factor (also denoted by a) and an offset (also denoted by b), and the shift number is fixed to be 6. An IC flag is coded for each PU to indicate whether IC applies for current PU or not. If IC applies for the PU, a set of IC parameters (i.e., a and b) are signaled to video decoder 300 and is used for motion compensation. In bi-prediction case, two scaling factors (one for each prediction direction) and one offset are signaled.

To save bits spent on IC parameters, chroma component shares the scaling factors with luma component and a fixed offset 128 is used.

In 3D-HEVC, IC is enabled for inter-view prediction. Different from WP and PBIC which signals IC parameters explicitly, coders for 3D-HEVC derive IC parameters based on neighboring samples of current CU and neighboring samples of reference block.

IC may apply to 2N×2N partition mode only. For AMVP mode, one IC flag is signaled for each CU that is predicted from inter-view reference picture. For merge mode, to save bits, an IC flag is signaled only when merge index of the PU is not equal to 0.

IC does not apply to a CU that is only predicted from temporal reference pictures. Linear IC model used in inter-view prediction is shown in the following equation:

$$p ( i , j ) = a * r ( i + d {v}_{x} , j + d {v}_{y} + b ) , where ( i , j ) ∈ P {U}_{c}$$

Here, PU_{c} is the current PU, (i, j) is the coordinate of pixels in PU_{c}, (dvₓ, dv_{y}) is the disparity vector of PU_{c}. p(i, j) is the prediction of PU_{c}, r is the PU's reference picture from neighboring view. a and b are parameters of the linear IC model.

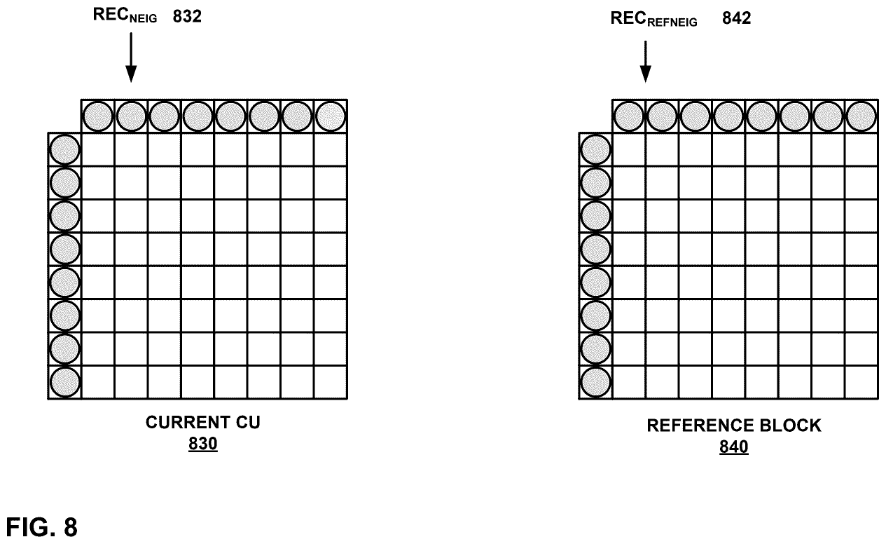

FIG. 8 is a conceptual diagram illustrating examples of neighboring pixels used to estimate parameters in an IC model with the reference block of the current block being found by using a disparity vector of the current PU. To estimate parameters a and b for a PU, video decoder 300 use two set of pixels as shown in FIG. 8:
1) available reconstructed neighboring pixels in the left column and above row of current CU 830 (the CU that contains current PU) (indicated through grey circles); and
2) Corresponding neighboring pixels of current CU's reference block 840 (indicated through grey circles). A reference block of the current CU is found by using a disparity vector of the current PU.

For example, Rec_{neig} 832 and Rec_{refneig} 842 denote a used neighboring pixel set of current CU 830 and reference block 840 of current CU 830, respectively, and 2N denotes the pixel number in Rec_{neig} and Rec_{refneig}. Then, a and b can be calculated as:

$$a = \frac{2 N \cdot {\sum }_{i = 0}^{2 N - 1} {Rec}_{neig} ( i ) \cdot {Rec}_{refneig} ( i ) - {\sum }_{i = 0}^{2 N - 1} {Rec}_{neig} ( i ) \cdot {\sum }_{i = 0}^{2 N - 1} {Rec}_{refneig} ( i )}{2 N \cdot {\sum }_{i = 0}^{2 N - 1} {Rec}_{refneig} ( i ) \cdot {Rec}_{refneig} ( i ) - {( {\sum }_{i = 0}^{2 N - 1} {Rec}_{refneig} ( i ) )}^{2}} \qquad ( 2 )$$

$$b = \frac{{\sum }_{i = 0}^{2 N - 1} R e {c}_{n e i g} ( i ) - a \cdot {\sum }_{i = 0}^{2 N - 1} R e {c}_{refneig} ( i )}{2 N} \qquad ( 3 )$$

In some cases, only a is used in a linear model and b is always set equal to 0, or only b is used and a is always set equal to 1. For example, video encoder 200 or video decoder 300 may use only a in a linear model or use only b.

Local illumination compensation (LIC) in JVET is now discussed. LIC is based on a linear model for illumination changes, using a scaling factor a (with a shift number fixed to be 6) and an offset b. LIC is enabled or disabled adaptively for each inter-mode coded coding unit (CU).

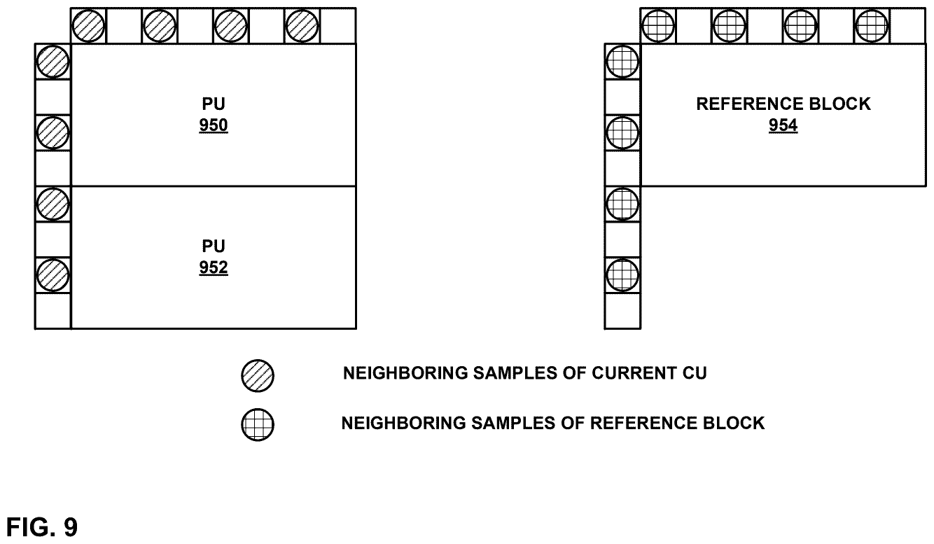

FIG. 9 is a conceptual diagram illustrating examples of neighboring samples used for deriving IC parameters. When LIC applies for a CU, video encoder 200 or video decoder 300 employ a least square error method to derive the parameters a and b by using the neighboring samples of the current CU and their corresponding reference samples. More specifically, as illustrated in FIG. 9 the subsampled (2:1 subsampling) neighboring samples (shown as circles with slashes) of the CU and the corresponding pixels (shown as circles with a checkboard pattern and identified by motion information of the current CU or sub-CU) in the reference picture are used. The IC parameters are derived and applied for each prediction direction separately. For example, PU 950 and PU 952 are depicted as well as subsampled neighboring samples of the current CU (which includes PU 950 and PU 952). Reference block 954, which is the reference block for PU 950 in list0, and subsampled neighboring samples of reference block 954 are also shown.

When a CU is coded with merge mode, the LIC flag is copied from neighboring blocks, in a way similar to motion information copy in merge mode. When a CU is otherwise encoded (e.g., not using merge mode), video encoder 200 signals an LIC flag to video decoder 300 to indicate whether LIC applies or not.

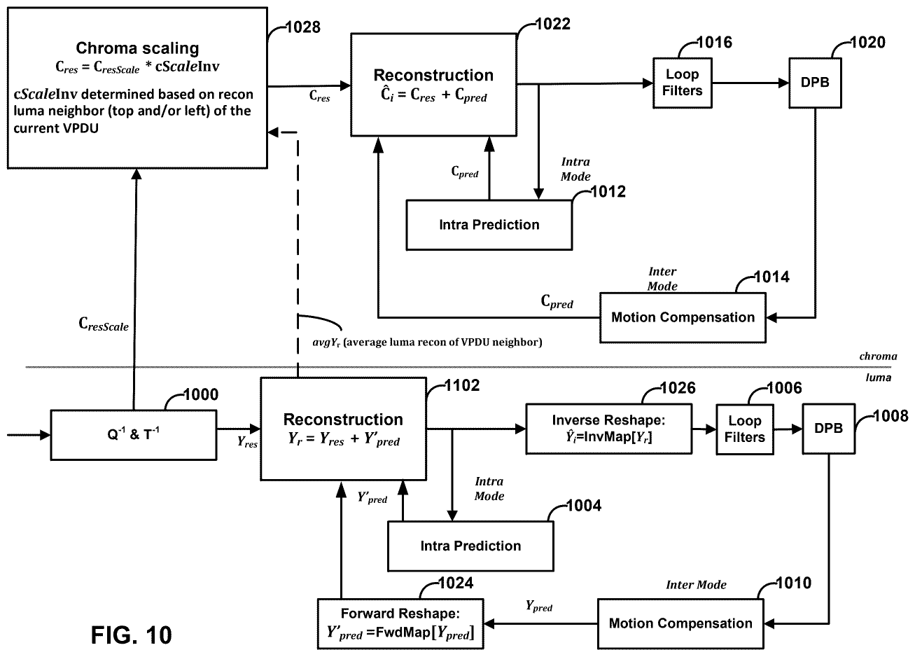

FIG. 10 is a block diagram illustrating an example luma mapping with chroma scaling (LMCS) architecture. In VVC, a coding tool called LMCS is added as a new processing block before the loop filters. LMCS has two main components: 1) in-loop mapping of the luma component based on adaptive piecewise linear models; 2) for the chroma components, luma-dependent chroma residual scaling is applied. FIG. 10 shows the LMCS architecture from the perspective of a decoder, such as video decoder 300. For example, video decoder 300 may implement LMCS as depicted in FIG. 10. For example, video decoder 300 may process the inverse quantization and inverse transform 1000, perform luma intra prediction 1004 and add the luma prediction together with the luma residual in reconstruction 1002 in the mapped domain. Video decoder 300 may process loop filters 1006 and 1016 (such as deblocking filter, adaptive loop filter, and sample adaptive offset), perform motion compensated 1010 and 1014, perform chroma intra prediction 1012, add the chroma prediction together with the chroma residual 1022, and store decoded pictures as reference pictures 1008 and 1020 in the original (e.g., non-mapped) domain. Forward mapping of the luma signal in forward reshape 1024, inverse mapping of the luma signal in inverse reshape 1026, and a luma-dependent chroma scaling process 1028 are LMCS functional blocks. Like most other tools in VVC, video encoder 200 can enable/disable LMCS at the sequence level using an SPS flag.

Luma mapping with a piecewise linear model is now discussed. The in-loop mapping of the luma component adjusts the dynamic range of the input signal by redistributing the codewords across the dynamic range to improve compression efficiency. Luma mapping makes use of a forward mapping function, FwdMap, and a corresponding inverse mapping function, InvMap. Video encoder 200 signals the FwdMap function using a piecewise linear model with 16 equal pieces. The InvMap function does not need to be signaled as video decoder 300 may derive the InvMap function from the FwdMap function.

Video encoder 200 signals the luma mapping model in the adaptation parameter set (APS) syntax structure with aps_params_type set equal to 1 (LMCS_APS). Up to four LMCS APS's may be used in a coded video sequence. In this example, only one LMCS APS may be used for a picture. Video encoder 200 may signal the luma mapping model using the piecewise linear model. The piecewise linear model partitions the input signal's dynamic range into 16 equal pieces, and for each piece, the linear mapping parameters of the piece may be expressed using the number of codewords assigned to that piece. For example, with a 10-bit input, each of the 16 pieces will have 64 codewords assigned to the piece by default. The signaled number of codewords is used to calculate the scaling factor and adjust the mapping function accordingly for that piece. At the slice level, video encoder 200 signals an LMCS enable flag to indicate if the LMCS process as depicted in FIG. 10 is applied to the current slice. If LMCS is enabled for the current slice, video encoder 200 signals an aps_id in the slice header to identify the APS that carries the luma mapping parameters.

Each i-th piece, i=0 . . . 15, of the FwdMap piecewise linear model is defined by two input pivot points InputPivot[ ] and two output (mapped) pivot points MappedPivot[ ].

The InputPivot[ ] and MappedPivot[ ] are computed as follows (assuming 10-bit video):

1) OrgCW = 64
2) For i = 0:16, InputPivot[ i ] = i * OrgCW
3) For i=0:16, MappedPivot[i] is calculated as follows:
MappedPivot[ 0 ] = 0;
for( i = 0; i <16 ; i++)
MappedPivot[ i + 1 ] = MappedPivot[ i ] + SignalledCW[ i]

where SignalledCW[i] is the signaled number of codewords for the i-th piece.

In FIG. 10, forward reshape 1024 and inverse reshape 1026 are shown. These boxes represent the forward reshaping of data from the pixel domain (also called the original domain) to a mapped domain and the inverse reshaping of data from the mapped domain to the pixel domain, respectively. As shown in FIG. 10, for an inter-coded block, motion-compensated prediction (e.g., motion compensation 1010) is performed in the original domain and then the motion-compensated prediction signal is converted to the mapped domain (e.g., by forward reshape 1024). In other words, after the motion-compensated prediction block Y_{pred} is calculated based on the reference signals in DPB 1008, video decoder 300 applies the FwdMap function (e.g., forward reshape 1024) to map or reshape the luma prediction block in the original domain to the mapped domain, Y′_{pred}=FwdMap (Y_{pred}). For an intra-coded block, the FwdMap function is not applied because intra prediction 1004 is performed in the mapped domain. After reconstructed block Y, is calculated, video decoder 300 applies the InvMap function (e.g., inverse reshape 1026) to convert the reconstructed luma values in the mapped domain back to the reconstructed luma values in the original domain (Ŷᵢ=InvMap(Yᵣ)). The InvMap function (e.g., inverse reshape 1026) is applied to both intra- and inter-coded luma blocks.

The luma mapping process (forward and/or inverse mapping) can be implemented using either look-up-tables (LUTs) or using on-the-fly computation. If LUTs are used, then FwdMapLUT and InvMapLUT can be pre-calculated and pre-stored for use at the tile group level, and forward and inverse mapping can be simply implemented as FwdMap(Y_{pred})=FwdMapLUT[Y_{pred}] and InvMap(Y)=InvMapLUT[Yᵣ], respectively. Alternatively, on-the-fly computation may be used. Take forward mapping function FwdMap as an example. In order to determine the piece to which a luma sample belongs, video decoder 300 may right shift the sample value by 6 bits (which corresponds to 16 equal pieces). Then, video decoder 300 may retrieve the linear model parameters for that piece and apply the linear model parameters on-the-fly to compute the mapped luma value. Let i be the piece index, a1, a2 be InputPivot[i] and InputPivot[i+1], respectively, and b1, b2 be MappedPivot[i] and MappedPivot[i+1], respectively. The FwdMap function may be as follows:

$$FwdMap ( {Y}_{p r e d} ) = ( ( b 2 - b 1 ) / ( a 2 - a 1 ) ) * ( {Y}_{p r e d} - a 1 ) + b 1 \qquad ( 4 )$$

The InvMap function can be computed on-the-fly in a similar manner. Generally, the pieces in the mapped domain are not of equal size. Therefore, the most straightforward inverse mapping process would require video decoder 300 to make comparisons in order to determine to which piece the current sample value belongs. Such comparisons increase decoder complexity. For this reason, VVC imposes a bitstream constraint on the values of the output pivot points MappedPivot[i] as follows. Assume the range of the mapped domain (for 10-bit video, this range is [0, 1023]) is divided into 32 equal pieces. If MappedPivot[i] is not a multiple of 32, then MappedPivot[i+1] and MappedPivot[i] cannot belong to the same piece of the 32 equal-sized pieces, e.g., MappedPivot[i+1]>>(BitDepthY−5) shall not be equal to MappedPivot[i]>>(BitDepthY−5). Thanks to such a bitstream constraint, the InvMap function can also be carried out using a simple right bit-shift by 5 bits (which corresponds to 32 equal-sized pieces) in order to determine the piece to which the sample value belongs.

Luma-dependent chroma residual scaling is now discussed. Chroma residual scaling is designed to compensate for the interaction between the luma signal and the luma signal's corresponding chroma signals. Video encoder 200 signals whether chroma residual scaling is enabled or not at the slice level. If luma mapping is enabled, video encoder 200 signals an additional flag to indicate if luma-dependent chroma residual scaling is enabled or not. When luma mapping is not used, luma-dependent chroma residual scaling is disabled. Further, luma-dependent chroma residual scaling is always disabled for chroma blocks whose area is less than or equal to 4.

Chroma residual scaling depends on the average value of top and/or left reconstructed neighboring luma samples of the current virtual pipeline data unit (VPDU). If the current CU is inter 128×128, inter 128×64, or inter 64×128, then video decoder 300 uses the chroma residual scaling factor derived for the CU associated with the first VPDU for all chroma transform blocks in that CU. Denote avgYr as the average of the reconstructed neighboring luma samples (see FIG. 6A). Video decoder 300 computes the value of C_{Scalelnv} through the following steps:
1) Find the index Y_{ldx} of the piecewise linear model to which avgYr belongs based on the InvMap function.
2) C_{Scalelnv}=cScaleInv[Y_{ldx}], where cScaleInv[ ] is a 16-piece LUT pre-computed table based on the value of SignalledCW[i] and an offset value signaled in the APS for chroma residual scaling process.

Unlike luma mapping, which is performed on a sample basis, C_{Scalelnv} is a constant value for the entire chroma block. With C_{Scalelnv}, chroma residual scaling is applied as follows:

$$Video encoder 200 : {C}_{Res S c a l e} = {C}_{Res} * {C}_{S c a l e} = {C}_{Res} / {C}_{ScaleInv}$$

$$Video encoder 300 : {C}_{Res} = {C}_{ResScale} / {C}_{S c a l e} = {C}_{ResScale} * {C}_{ScaleInv}$$

When OBMC is applied, top and left boundary pixels of a CU are refined using neighboring block's motion information with a weighted prediction as described in JVET-L0101.

Conditions of not applying OBMC are as follows:
When OBMC is disabled at SPS level; When current block has intra mode or IBC mode;
When current block applies LIC; When current luma block area is smaller or equal to 32.

A subblock-boundary OBMC is performed by applying the same blending to the top, left, bottom, and right subblock boundary pixels using neighboring subblocks' motion information. It is enabled for the subblock based coding tools:

Affine AMVP modes; Affine merge modes and subblock-based temporal motion vector prediction (SbTMVP); Subblock-based bilateral matching.

When OBMC mode is used in CIIP mode with LMCS, inter blending is performed prior to LMCS mapping of inter samples. LMCS is applied to blended inter samples which are combined with LMCS applied intra samples in CIIP mode,

$${Inter}_{p r e d Y}^{′} = \frac{( 128 - {w}_{1} ) \times {Inter}_{p r e d Y} + {w}_{1} \times {OBMC}_{p r e d Y}}{128}$$

$$PredY = \frac{( 4 - {w}_{0} ) \times FwdMap ( {Inter}_{p r e d Y}^{′} ) + {w}_{0} \times {Intra}_{p r e d Y}}{4} ,$$

where Inter_{predY} represents the samples predicted by the motion of current block in the original domain, Intra_{predY} represents the samples predicted in the mapped domain, OBMC_{predY} represents the samples predicted by the motion of neighboring blocks in the original domain, and w₀ and w₁ are the weights.

In the template matching based OBMC scheme, instead of directly using the weighted prediction, the prediction value of CU boundary samples derivation approach is determined according to the template matching costs, including using current block's motion information only, or using neighboring block's motion information as well with one of the blending modes.

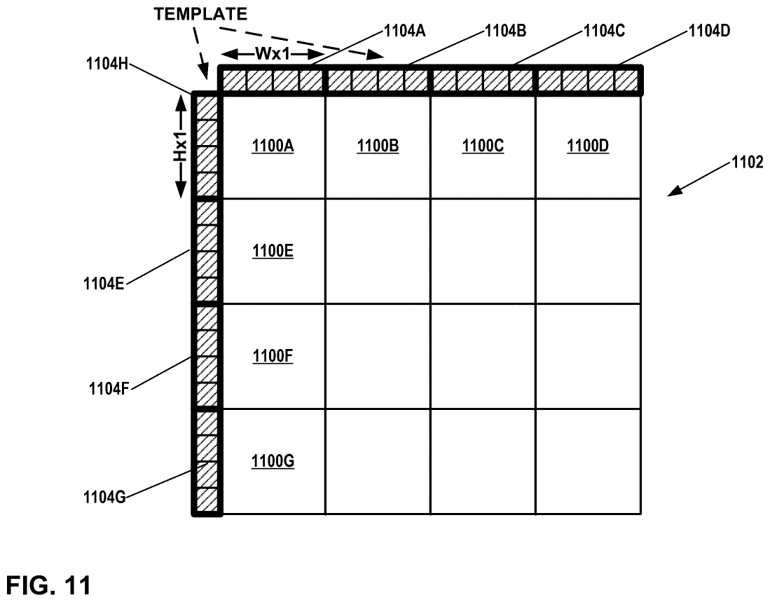

FIG. 11 is a conceptual diagram illustrating example templates for TM-OBMC. In this scheme, for each top block (i.e., each of blocks 1100A, 1100B, 1100C, 1100D) with a size of 4×4 at the top boundary of a CU 1102, the above template size (e.g., templates 1104A, 1104B, 1104C, 1104D) equals to 4×1. If N adjacent blocks have the same motion information, then the above template size is enlarged to 4N×1 since the motion compensation operation can be processed at one time. For each left block (i.e., blocks 1100A, 1100E, 1100F, 1100G) with a size of 4×4 at the left CU boundary, the left template (1104E, 1104F, 1104G, 1104H size equals to 1×4 or 1×4N (as depicted in FIG. 11).

Specifically, in the example of FIG. 11, for each 4×4 top block (i.e., each of blocks 1100A, 1100B, 1100C, 1100D) or other group of N 4×4 blocks, the prediction value of boundary samples is derived following the below steps.

Take block 900A as the current block and its above neighboring block AboveNeighbor_A for example. The operation for left blocks is conducted in the same manner.

First, three template matching costs (Cost1, Cost2, Cost3) are measured by SAD between the reconstructed samples of a template and its corresponding reference samples derived by MC process according to the following three types of motion information:
Cost1 is calculated according to A's motion information.
Cost2 is calculated according to AboveNeighbor_A's motion information.
Cost3 is calculated according to weighted prediction of A's and AboveNeighbor_A's motion information with weighting factors as 3/4 and 1/4 respectively.

Second, choose one approach to calculate the final prediction results of boundary samples by comparing Cost1, Cost2 and Cost 3.

The original motion compensation result using current block's motion information is denoted as Pixel1, and the motion compensation result using neighboring block's motion information is denoted as Pixel2. The final prediction result is denoted as NewPixel.
If Cost1 is minimum, then NewPixel(i,j)=Pixel1(i,j).
If (Cost2+(Cost2>>2)+(Cost2>>3))<=Cost1, then blending mode 1 is used.

For luma blocks, the number of blending pixel rows is 4.

$$N e w P i x e l ( i , 0 ) = ( 26 \times P i x e l 1 ( i , 0 ) + 6 \times P i x e l 2 ( i , 0 ) + 16 ) >> 5$$

$$NewP i x e l ( i , 1 ) = ( 7 \times P i x e l 1 ( i , 1 ) + P i x e l 2 ( i , 1 ) + 4 ) >> 3$$

$$NewP i x e l ( i , 2 ) = ( 15 \times P i x e l 1 ( i , 2 ) + P i x e l 2 ( i , 2 ) + 8 ) >> 4$$

$$NewP i x e l ( i , 3 ) = ( 31 \times P i x e l 1 ( i , 3 ) + P i x e l 2 ( i , 3 ) + 16 ) >> 5$$

For chroma blocks, the number of blending pixel rows is 1.

$$N e w P i x e l ( i , 0 ) = ( 26 \times P i x e l 1 ( i , 0 ) + 6 \times P i x e l 2 ( i , 0 ) + 16 ) >> 5$$

If Cost1<=Cost2, then blending mode 2 is used.

For luma blocks, the number of blending pixel rows is 2.

$$N e w P i x e l ( i , 0 ) = ( 15 \times P i x e l 1 ( i , 0 ) + P i x e l 2 ( i , 0 ) + 8 ) >> 4$$

$$NewPixel ( i , 1 ) = ( 31 \times P i x e l 1 ( i , 1 ) + P i x e l 2 ( i , 1 ) + 16 ) >> 5$$

For chroma blocks, the number of blending pixel rows/columns is 1.

$$N e w P i x e l ( i , 0 ) = ( 15 \times P i x e l 1 ( i , 0 ) + P i x e l 2 ( i , 0 ) + 8 ) >> 4$$

Otherwise, blending mode 3 is used.

For luma blocks, the number of blending pixel rows is 4.

$$N e w P i x e l ( i , 1 ) = ( 7 \times P i x e l 1 ( i , 1 ) + P i x e l 2 ( i , 1 ) + 4 ) >> 3$$

$$NewPixel ( i , 2 ) = ( 15 \times P i x e l 1 ( i , 2 ) + P i x e l 2 ( i , 2 ) + 8 ) >> 4$$

$$NewPixel ( i , 3 ) = ( 31 \times P i x e l 1 ( i , 3 ) + P i x e l 2 ( i , 3 ) + 16 ) >> 5$$

For chroma blocks, the number of blending pixel rows is 1.

$$N e w P i x e l ( i , 0 ) = ( 7 \times P i x e l 1 ( i , 0 ) + P i x e l 2 ( i , 0 ) + 4 ) >> 3$$

IBC was generally considered as a specialized coding tool for screen contents. Because screen contents are usually rendered at integer grid with sharp signals, IBC generally works with integer-pel block vector precision (or higher, such as, 4-pel block vector precision). However, when IBC is used in coding of nature content, the limitation imposed on BV to support only integer-pel precision has become a major performance bottleneck on IBC, because repetitive patterns may not always sit exactly on grid samples. Thus, it may be desirable to extend IBC to supporting BV's pointing to fractional-pel positions on a reference picture (e.g., the reconstructed area of the current frame).

IBC and IntraTMP are inter-changeable techniques, and thus when techniques applicable to either IBC or IntraTMP are mentioned in the disclosure, the techniques may be used for IBC, IntraTMP, or both IBC and IntraTMP.

The availability check of BV (e.g., which video encoder 200 or video decoder 300 may use for IBC and/or IntraTMP) may be to determine the minimal area (denoted as A) of reference samples required before reference sample padding and interpolation are performed. A BV may be considered valid if all the reference samples in A are within IBC's or IntraTMP's valid search range. There are different techniques disclosed hereinafter. If not otherwise stated, BVx and BVy may denote a given BV's horizontal and vertical components, respectively, and a M-tap filter may be used for horizontal interpolation and N-tap filter may be used for vertical interpolation (e.g., M and N may be typically 2, 4, 6, 8, 10, 12, or the like), and the current block size may be W×H (i.e., W for block width and H for block height).

In an example, the minimal area, A, is defined as W×H pointed to by the truncated version of the given BV. A truncated BV is defined as ((BVx>>r)<<r, (BVy>>r)<<r), where r is the log 2-scale storage precision for BV and MV (e.g., 2 in HEVC and 4 in VVC and ECM).

In another example, the minimal area, A, could be a rectangular shape with a size smaller than W×H, but at least as large as Wₘᵢₙ×Hₘᵢₙ, where Wₘᵢₙ could be as small as 1 or as large as W, and Hₘᵢₙ could be as small as 1 or as large as H. For example, the minimum area can be 1×1 or 4×4. For another example, the minimum area could be (W/2)×(H/2) to maintain interpolation performance. For another example, the minimum area could be max (4, (W/2))×max (4, (H/2)).

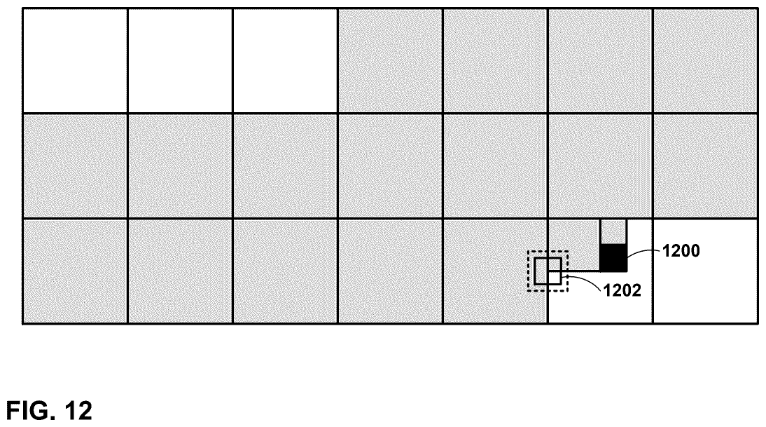

FIG. 12 is a conceptual diagram illustrating an example of a valid search range of IBC or IntraTMP according to the techniques of this disclosure. Video encoder 200 or video decoder 300 may use such a search range for IBC and/or IntraTMP. In FIG. 12, each large box represents a CTU, the shaded boxes represent a valid search range, block 1200 is the current block, block 1202 is a reference block pointed to by the truncated BV and the dotted block is the minimal area required for performing interpolation. As illustrated in FIG. 12, the minimal area A of size Wₘᵢₙ×Hₘᵢₙ falls within the area of IBC's or IntraTMP's valid search range (the shaded boxes). The minimal area is pointed to by (((BVx>>r)<<r)+Δx, ((BVy>>r)<<r)+Δy), where Δx=((W−Wₘᵢₙ)>>1) and Δy=((H−Hₘᵢₙ)>>1).

In another example, the minimal area, A, could be still (W+(M−1))×(H+(N−1)) pointed to by (BVx−(M/2)+1, BVy−(N/2)+1), as illustrated in FIG. 12, and the overlapping area between A and the valid search range (the shaded boxes) is not empty.

Reference sample padding is now discussed. When a given BV is a valid BV verified by using an example above, a reference padding may be applied depending on whether the required reference sample area (e.g., of size (W+(M−1))×(H+(N−1))) falls completely within the valid search range of IBC or InrtaTMP or not. If not, a reference sample padding techniques may be applied before interpolation is performed. For example, video encoder 200 or video decoder 300 may apply reference sample padding techniques before interpolation is performed.

In an example, the padding techniques include firstly performing padding along a horizontal direction and then a vertical direction. For a rectangular A, it is known that all reference samples within A are valid.

For example, the horizontal padding may start from the top-left sample to bottom-left sample of A and then start from the top-right sample to bottom-right sample. When padding is needed, a to-be-padded reference sample copies the nearest horizontal available one in the valid search area to fill itself.

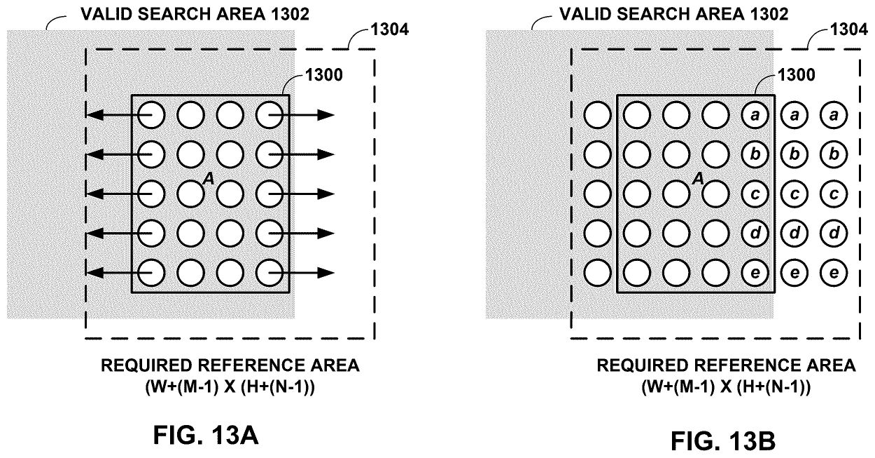

FIGS. 13A-B are conceptual diagrams illustrating an example of horizontal padding according to the techniques of this disclosure. The example of FIGS. 13A-B is directed to padding associated with a 4-tap interpolation filter. FIG. 13A depicts samples within rectangular area A 1300, valid search area 1302, and reference area 1304 prior to horizontal padding. FIG. 13B depicts samples within rectangular area A 1300, valid search area 1302, and samples within reference area 1304 after horizontal padding. When scanning toward the left, all samples are already available (shown as shaded), thus padding is not needed. When scanning toward right, some samples are unavailable and thus may be padded using the horizontally nearest available samples in the valid search area. For example, the shaded portion represents the valid search area of IBC or IntraTMP.

Padding may not be always needed if the scanned direction is within the valid search range of IBC or IntraTMP. Thus, in FIG. 13B, the left direction is just filled with already existing reference samples in the valid search area. Padding may be needed when the scanning direction goes into an invalid search area. In this case, the invalid part is padded by using the horizontally nearest available reference samples of the valid search area. Thus, in FIG. 13B, reference samples of the right direction are padded using the horizontally nearest reference samples.

Then, the vertical padding may start from the top-left sample to top-right sample of the area generated by the horizontal padding techniques (denoted by A_{H} which is of size (W+(M−1))×Hₘᵢₙ) and then from bottom-left sample to bottom-right sample of A_{H}. When padding is needed, a to-be-padded reference sample copies the vertically nearest available reference sample from the valid search area plus A_{H} to fill itself.

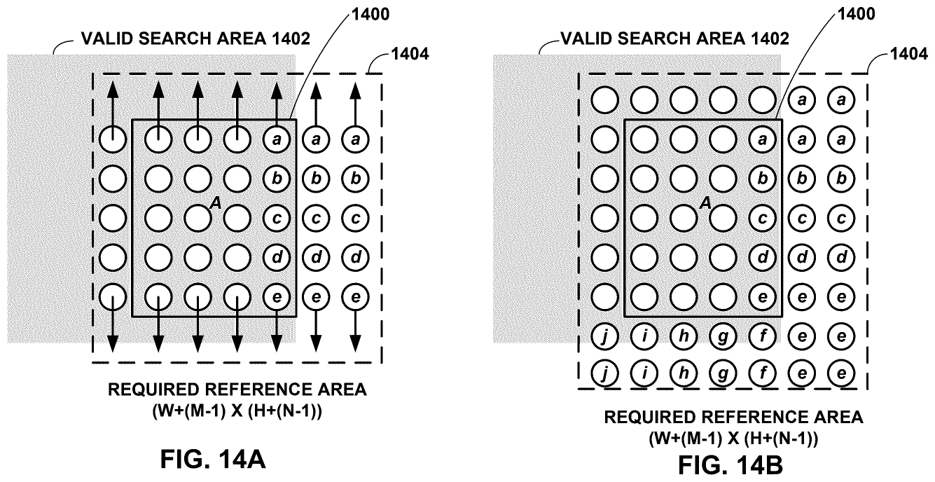

FIGS. 14A-B are conceptual diagrams illustrating an example of vertical padding according to the techniques of this disclosure. The example of FIGS. 14A-B is directed to padding associated with a 4-tap interpolation filter. FIG. 14A depicts samples within rectangular area A 1400 (which may be an example of rectangular area A 1300 of FIG. 13A), valid search area 1402 (which may be an example of valid search area 1302 of FIG. 13A), and reference area 1404 (which may be an example of reference area 1304 of FIG. 13A) prior to vertical padding, but after horizontal padding. FIG. 14B depicts samples within rectangular area A 1400, valid search area 1402, and samples within reference area 1404 after both horizontal padding and vertical padding. When scanning upward, some samples are already available, thus padding is not needed, while others are unavailable (e.g., the top-right most two samples) which may require padding using vertically nearest available samples in the valid search area plus those samples generated by horizontal padding. When scanning downward, available samples may not need padding (e.g., the sample f and those to sample f's left), while other samples that do not overlap the valid search area may be padded using vertically nearest available samples in the valid search area plus those samples generated by horizontal padding.

Padding may not be always needed if the scanning direction is within the valid search range of IBC or IntraTMP. Thus, in FIG. 14B, the upward direction is partially filled with already existing reference samples in A_{H}, while some samples may need padding (e.g., the 2 most top-right samples in the required reference area). Similarly, when scanning downward, available samples may not need padding (e.g., the sample f and those to the left of sample fin FIG. 14B), while other samples that do not overlap with the valid search area may be padded using the vertically nearest available samples in the valid search plus those generated by horizontal padding (e.g., A_{H}).

In another example, given the required reference sample area being (W+(M−1))×(H+(N−1)) pointed to by (BVx−(M/2)+1, BVy−(N/2)+1), the padding techniques may still include firstly performing padding along the horizontal direction and then the vertical direction.

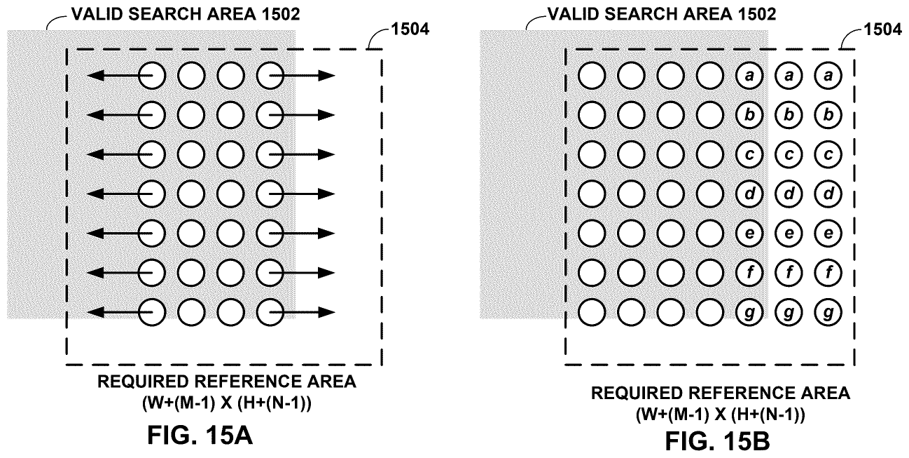

FIGS. 15A-B are conceptual diagrams illustrating an example of horizontal padding according to the techniques of this disclosure. As shown in the example of FIGS. 15A-B, horizontal padding takes place first to pad horizontally unavailable samples with horizontally nearest available reference samples. FIG. 15A depicts valid search area 1502 and samples within reference area 1504 prior to horizontal padding. FIG. 15B depicts valid search area 1502 and samples within reference area 1504 after horizontal padding.

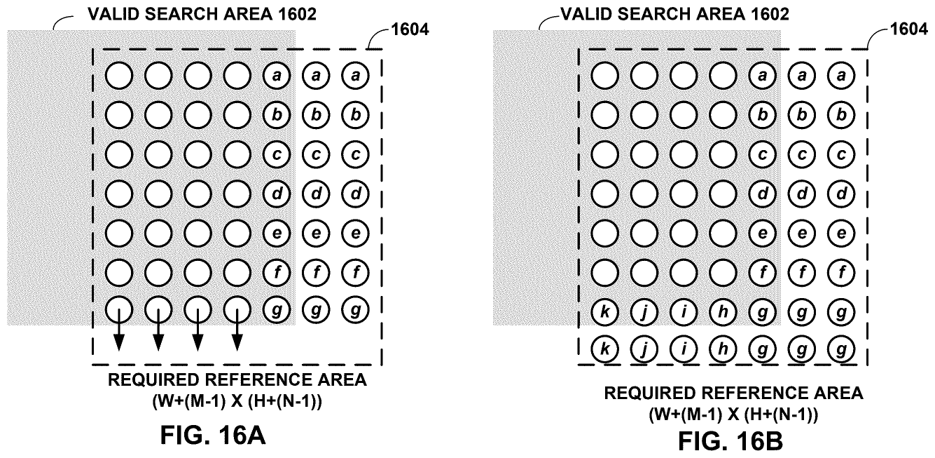

In the example of FIGS. 15A-B, since there are no available reference samples for the last row within the area of A, thus the last row is the only row in the example that cannot utilize padding. In this example, then vertical padding may be performed. FIGS. 16A-B are conceptual diagrams illustrating an example of vertical padding according to the techniques of this disclosure. FIG. 16A depicts valid search area 1602 (which may be an example of valid search area 1502 of FIG. 15A), and reference area 1604 (which may be an example of reference area 1504 of FIG. 15A) prior to vertical padding, but after horizontal padding. FIG. 16B depicts valid search area 1602 and samples within reference area 1604 after horizontal padding and vertical padding.

In the example of FIGS. 16A-B, vertical padding may be performed to pad unavailable samples using vertically nearest samples from the valid area of A plus those padded samples by horizontal padding techniques of FIGS. 15A-B.

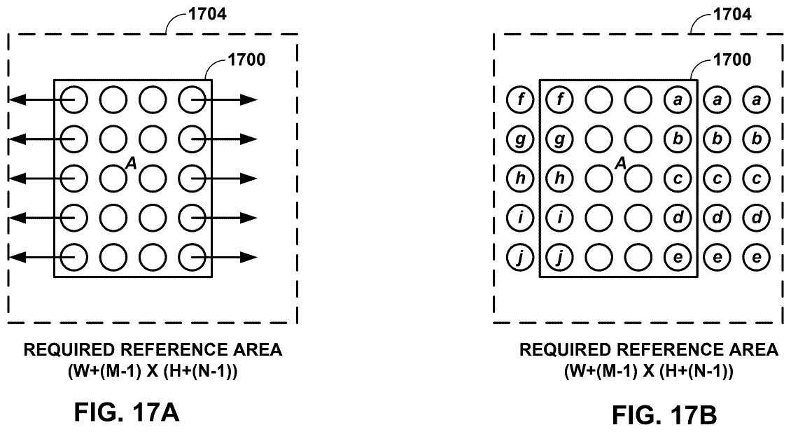

FIGS. 17A-B are conceptual diagrams illustrating an example of unconditional padding for the horizontal direction according to the techniques of this disclosure. FIG. 17A depicts samples within rectangular area A 1700, and reference area 1704 prior to horizontal padding. FIG. 17B depicts samples within rectangular area A 1700, and samples within reference area 174 after horizontal padding. In an example, unconditional padding techniques may be applied when the minimal area A is configured as large as the current CU (W×H in size) for a BV availability check. For example, video encoder 200 or video decoder 300 may apply unconditional padding techniques. The unconditional padding may be triggered when at least one of the required reference sample areas (e.g., of size (W+(M−1))×(H+(N−1))) falls outside the valid search range of IBC (or InrtaTMP). The unconditional padding techniques may perform padding (e.g., horizontally and then vertically) under the assumption that reference samples outside the minimal area A are regarded as unavailable.

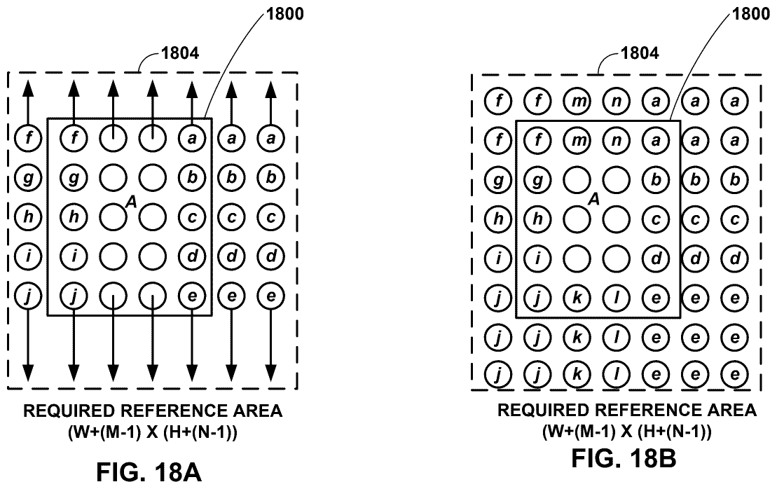

FIGS. 18A-B are conceptual diagrams illustrating an example of unconditional padding for the vertical direction according to the techniques of this disclosure. FIG. 18A depicts samples within rectangular area A 1800 (which may be an example of rectangular area A 1700 of FIG. 17A), and reference area 1804 (which may be an example of reference area 1704 of FIG. 17A) prior to vertical padding, but after horizontal padding. FIG. 18B depicts samples within rectangular area A 1800, and samples within reference area 184 after horizontal padding and vertical padding.

Video encoder 200 or video decoder 300 may perform the techniques discussed with respect to any of FIGS. 13A-B through FIGS. 18A-B.

Applications with fraction-pel BV are now discussed. When fraction-pel BV validity check and reference padding are both supported, IBC and IntraTMP related applications and tools can be further extended to performing with fraction-pel BV. For example, video encoder 200 or video decoder 300 may perform fraction-pel BV techniques.

In an example, IBC-MBVD merge mode may support fractional-pel offsets instead of (or in addition to) supporting integer-pel offsets. A sps-, picture-, slice- or tile-level flag may be signaled to indicate the switching between integer-pel offsets and fractional-pel offsets. For example, video encoder 200 may signal such a flag to video decoder 300 to indicate the switching between integer-pel offsets and fractional-pel offsets. This flag may be present in the bitstream when fraction-pel BV is supported. In some examples, this flag may be present in a picture header to indicate whether blocks within the picture use or support integer-pel offsets or fractional-pel offsets. When this flag is not present, the flag value may be inferred as 0. When fraction-pel BV and fractional-pel offsets are supported in a codec (e.g., video encoder 200 or video decoder 300), the integer-pel offset may be shifted right by X bits, where X could be 1, 2, 3, or 4. For example, in VVC and ECM, the configuration could be 2 to indicate the use of quarter-pel offsets.

In an example, IBC may support the 6-tap switchable filter, that VVC and ECM use, to perform interpolation when AMVR mode is H-Pel mode and at least a BV component is pointing to a half-pel phase on the current frame.

In an example, the configuration follows VVC and ECM that uses the 6-tap switchable filter when AMVR is H-Pel mode and at least a BV component pointing to half-pel phase on the current frame.

In another example, IBC does not use the 6-tap switchable filter. Instead, IBC uses a default filter (e.g., 8-tap filter of HEVC and VVC, or 12-tap filter of ECM) to perform interpolation.

In another example, an sps-, picture-, slice- or tile-level flag may be signaled to indicate whether the 6-tap switchable filter is applicable for IBC. When the flag is set equal to True, the 6-tap filter is used when AMVR mode is H-Pel mode and at least a BV component is pointing to a half-pel phase on the current frame; otherwise, when the flag is False, the default filter is used.

In an example, a high-level syntax flag (e.g., indicated at sequence, picture, subpicture, slice or tile level) may be used for IBC to switch between the default luma interpolation filter of IBC and an alternative filter. The default luma interpolation filter may be pre-defined, which may be an 8-tap filter of HEVC and VVC, or the 8-tap and/or 12-tap filters of ECM. The alternative interpolation filter may include a shorter (e.g., lower) number of filter taps, e.g., 4 or 2. If video encoder 200 or video decoder 300 takes “2”, then a bilinear interpolation filter may be used. For example, if the alternative interpolation filter has two taps, then a bilinear interpolation filter may be used as the alternative interpolation filter. If video encoder 200 or video decoder 300 takes “4”, then the below 4-tap luma interpolation filter may be used. For example, if the alternative interpolation filter has four taps, the below example may be used as the alternative interpolation filter.

```
{
  { 0, 64, 0, 0, },
  { −4, 54, 16, −2, },
  { −4, 36, 36, −4, },
  { −2, 16, 54, −4, },
};
```

For example, video encoder 200's and/or video decoder 300's underlying luma filter may be an 8-tap filter (or a 6-tap filter, depending on whether a 6-tap switchable filter is used as described above) and the alternative luma filter may be a 4-tap filter. Then, when the high-level syntax flag is false, the underlying luma filter may be used; otherwise, when the high-level syntax flag is true, then the underlying luma filter is replaced by using the 4-tap filter, in this example.

It is noted that when this 4-tap luma filter is used, the 4-tap luma filter's filter coefficients may be scaled up by a factor of n before use, for example, depending on the underlying video codec. For example, n=1 may be used for a VVC and/or HEVC video codec and n=4 may be used for an ECM video codec. It is also noted that if BV in a video codec is stored in a finer precision than quarter-pel precision, then the fractional portion of the BV may be right-shifted before the 4-tap filter is used in the interpolation filtering process. For example, VVC and ECM both use storage precision for MV and BV at 1/16-pel precision (which means that 4 bits after the integer precision is kept (e.g., used or reserved, for the fractional precision portion), and the fractional portion of MV and BV may be right-shifted by 2 before the interpolation filtering starts.

In an example, IBC may separate the same CABAC context modeler of AMVR mode from CABAC context modeler of inter prediction mode. In ECM and VVC, they share the same CABAC context modeler of AMVR. This example creates another CABAC context modeler only for IBC's AMVR mode. The initial state of the CABAC context modeler could be copied from that of inter AMVR's, and the initial state of the CABAC context modeler for an I-Slice could be copied from either that of B- or P-slice's.

In another example, IBC may still share the same CABAC context modeler of inter prediction's AMVR mode. However, since the initial state of the AMVR's context modeler is undefined for an I-Slice, this example initializes the initial state of an I-Slice CABAC context modeler for AMVR modes using that of a B- or P-slice.

In an example, OBMC now can be used for IBC according to an sps-, picture-, slice- or tile-level flag indicated in the bitstream, or alternatively, this flag need not be signaled and may be inferred to be True when fraction-pel BV is supported.

For example, when OBMC is enabled for IBC or IntraTMP, if a neighboring block is IBC or IntraTMP mode and the neighboring block is not coded by IBC-CIIP mode, the neighboring block BV may be inferred to perform OBMC for the current block. It may be noted that the current block is also an IBC or IntraTMP block.

For example, when OBMC is enabled for IBC or IntraTMP, if a neighboring block is inter, IBC or IntraTMP mode and the neighboring block is not coded by IBC-CIIP mode, the neighboring block MV or BV may be inferred to perform OBMC for the current block. It may be noted that the current block is also an IBC or IntraTMP block.

For example, when OBMC is enabled for IBC or IntraTMP, if a neighboring block is Inter, IBC or IntraTMP mode and the neighboring block is not coded by IBC-CIIP and Inter-CIIP mode, the neighboring block MV or BV may be inferred to perform OBMC for the current inter, IBC or IntraTMP block. It may be noted that the current block type is not constrained to IBC and IntraTMP; as instead, the current block could be inter, IBC, or IntraTMP mode.

In another example, in addition to neighboring blocks' BVs and MVs, their LIC flags may also be inferred in the OBMC process to generate the prediction samples of OBMC hypotheses before current block prediction samples are blended with those of the OBMC hypotheses. The example can be combined with the techniques discussed above.

In some examples, when LMCS is enabled and fractional-pel interpolation takes place for IBC, one of the below techniques may apply: (Low-complexity techniques) The fractional-pel interpolation applies using the LMCS domain samples directly; (High-complexity techniques) The LMCS domain samples are mapped back to a pixel domain and then fractional-pel interpolation applies using these pixel domain samples. Once done, the interpolated prediction samples are mapped from pixel domain back to LMCS domain.

In an example, when fraction-pel BV is supported, the value N as described above with respect to BVD MSB bins is assigned differently when fractional-pel BV is supported. When the bitstream supports fractional-pel BV, the value of N may be defined as N=5 for fractional-pel AMVR modes (e.g., quarter-pel AMVR mode and half-pel AMVR mode, or affine's 1/16-pel AMVR mode) and N=3 for the rest of AMVR modes (e.g., integer-pel mode and four-pel mode). In yet another example, when the bitstream supports fractional-pel BV, the N may be defined as N=5 for the finest fractional-pel AMVR mode (e.g., quarter-pel AMVR mode for regular AMVP mode and 1/16-pel AMVR mode for affine AMVP mode) and N=3 for the rest of AMVR modes.

In an example, when fraction-pel BV is supported, template matching for IBC merge mode or IntraTMP mode may search beyond the integer-pel precision and go down to a pre-defined precision, e.g., half-pel, quarter-pel, 1/8-pel or 1/16-pel precision.

In an example, when fraction-pel BV is supported, template matching for IBC AMVP mode or IntraTMP mode could search beyond the integer-pel precision according to the setting of AMVR mode. For example, the template matching may start searching from four-pel precision (e.g., the coarsest one) and stop searching at a specific BV precision as indicated by AMVR.

In some examples, when AMVR=Four-pel, template matching is used to just search at four-pel precision. In some examples, when AMVR=Integer-pel, template matching is used to search from four-pel precision and then the integer-pel precision.

In some examples, when AMVR=Half-pel, template matching is used to search from four-pel precision, and then search the integer-pel precision, and stop (either searching or not) at half-pel precision. In some examples, when AMVR=Quarter-pel, template matching is used to search from four-pel precision, and then search the integer-pel precision, and then search the half-pel precision, and stop (either searching or not) at quarter-pel precision.

In an example, the luma interpolation filter used to generate the template of LIC for IBC/IntraTMP is pre-defined. For example, the luma interpolation filter may be a 2-tap bilinear filter for low-complexity use or be the same default filter as used for inter prediction (e.g., 8-tap filter for VVC and HEVC, or 12-tap filter for ECM) in high-complexity needs. Similarly, the chroma filter used to generate the template of LIC for IBC/IntraTMP may also be pre-defined. For example, the chroma filter may be a 2-tap bilinear filter for low-complexity use or be the same default filter as used for inter prediction (e.g., 4-tap filter for VVC and HEVC, or 6-tap filter for ECM) in high-complexity needs.

In an example, when generating the reference template block to perform ARMC (e.g., that reordered merge or AMVP candidate list based on template matching cost) for IBC, the interpolation filter configuration may be the same as the aforementioned interpolation filter for LIC (e.g., 2-tap filter or codec-specific default filter).

For example, video encoder 200 or video decoder 300 may generate a reference template block without LIC applied. When a LIC flag is enabled, this reference template block and the current template block may be used to derive LIC model parameters which video encoder 200 or video decoder 300 may apply to the reference template block before computing the difference (e.g., the template matching cost) between the current template block and the reference template block.

In such examples, the interpolation filter used to generate the reference template block could be any interpolation filter and may not need to be the same as the interpolation filter for LIC or for motion compensation. However, using the same interpolation filter as the LIC interpolation filter may reduce complexity of a hardware implementation as video encoder 200 or video decoder 300 do not need to interpolate the same reference template block twice. In other words, if video encoder 200 or video decoder 300 were to use a different interpolation filter when generating the reference template block than the interpolation filter for LIC, then video encoder 200 or video decoder 300 may have to generate the reference template block twice (e.g., once using a first interpolation filter and another using the interpolation filter for LIC).

In an example, when fraction-pel BV is supported, the AMVP candidate list of one-dimension BV mode discussed above may be modified. In ECM8, the setting may be as follows:
a. Horizontal one-dimension mode

$$i . AMVP candidate 0 = ( max ( - W , - PosX ) << r , 0 )$$

$$ii . AMVP candidate 1 = ( - PosX << r , 0 )$$

b. Vertical one-dimension mode

$$i . AMVP candidate 0 = ( 0 , max ( - H , - TopY ) << r , 0 )$$

$$ii . AMVP candidate 1 = ( 0 , - TopY << r , 0 ) ,$$

where r is the log 2-scale storage precision for BV and MV (e.g., 2 in HEVC and 4 in VVC and ECM), W×H is the current block size, PosX is current block's horizontal position in the current frame, and TopY is the max number of samples between current block and the top boundary of the valid search area.

Instead of following ECM8, this example changes the setting to add an additional offset to AMVP candidate 0 when fraction-pel BV is supported in the bitstream, as follows:
a. Horizontal one-dimension mode

$$i . AMVP candidate 0 = ( max ( - W , - PosX ) << r , 0 ) + ( Δ x , 0 )$$

$$ii . AMVP candidate 1 = ( - PosX << r , 0 )$$

b. Vertical one-dimension mode

$$i . AMVP candidate 0 = ( 0 , max ( - H , - TopY ) << r ) + ( 0 , Δ ys )$$

$$ii . AMVP candidate 1 = ( 0 , - TopY << r )$$

where (Δx, Δy)=(3<<(r−2), 3<<(r−2)) for quarter-pel precision and (Δx, Δy)=(1<<(r−1), 1<<(r−1)) for half-pel precision. For other AMVR modes, (Δx, Δy)=(0, 0)

In an example, when dual I-tree is enabled and IBC is also enabled, the chroma BV selection (discussed above) is changed. In this example, video encoder 200 or video decoder 300 firstly form a chroma BV candidate list as described above that takes BVs from a collocated luma area. Then, in this example, video encoder 200 or video decoder 300 may apply a pruning process to stop adding repeated BVs into the chroma BV candidate list. ARMC may apply to sort the candidate list based on template matching and trim down the list size to N if the size is larger than N (where N could be the same as luma merge mode, or any integers smaller, or be indicated explicitly in sps-, picture-, slice-, tile-level syntax). Then, an index is sent, (e.g., video encoder 200 may send an index) when chroma BV mode is used for a block in dual I-tree structure, to indicate which candidate from the N candidates is selected.

In another example, video encoder 200 or video decoder does not only take BV's from collocated luma area, but also applies the same merge candidate construction process to add more candidates into the chroma BV candidate list. Video encoder 200 or video decoder may apply the pruning process to remove similar BV when adding candidate BVs into the chroma BV candidate list. Video encoder 200 or video decoder may apply ARMC and trim down the list size to N. Then, video encoder 200 may send an index to indicate which candidate from the N candidates is selected.

In an example, every IBC merge mode (e.g., regular IBC merge mode, IBC-MBVD merge mode, TM-IBC merge mode) may not be present (e.g., indicated) in a bitstream due to the fact that some high-level syntax controls (e.g., at a sequence, picture, subpicture, tile, or slice level) may disable such modes. When IBC merge modes are all disabled, the syntax that is used to indicate the maximum number of IBC merge candidates may not be signaled in the bitstream (e.g., by video encoder 200), and a default value of the maximum number of IBC merge candidates may be set equal to an integer number N, where N may typically be, but is not limited to, 6.

In an example, regular IBC merge mode may not be present (e.g., indicated) in a bitstream due to that some high-level syntax controls (e.g., at a sequence, picture, subpicture, tile, or slice level) may disable the regular IBC merge mode. When the regular IBC merge mode is disabled, the syntax that is used to indicate the maximum number of IBC merge candidates may not be signaled in the bitstream (e.g., by video encoder 200), and a default value of the maximum number of IBC merge candidates may be set equal to an integer number N, where N may typically be, but is not limited to, 6.

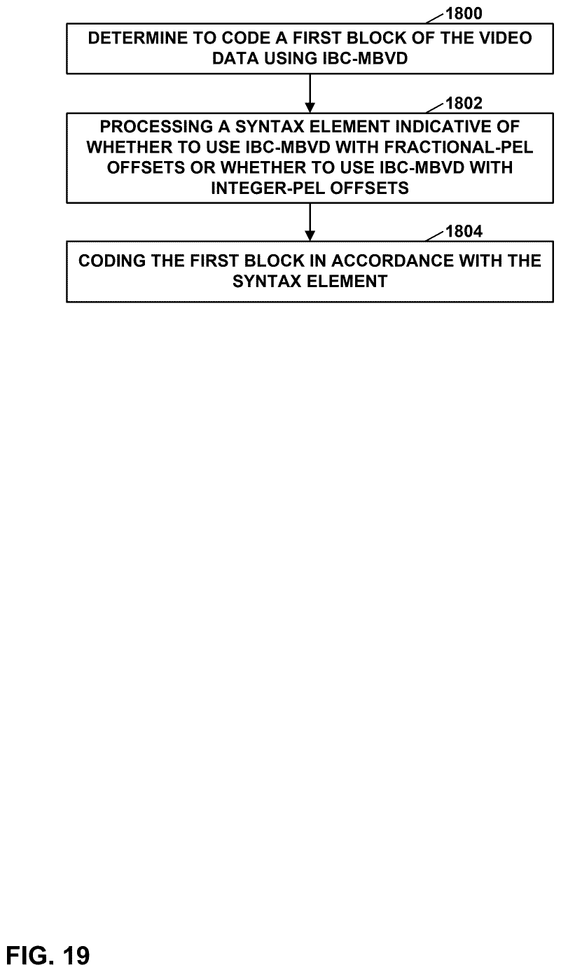

FIG. 19 is a flowchart illustrating an example method for coding a block of video data using IBC-MBVD. Video encoder 200 or video decoder 300 may determine to code a first block of the video data using IBC-MBVD (1900). For example, video encoder 200 may perform multiple encoding passes to test combinations of encoding parameters, including using IBC-MBVD. Video encoder 200 may determine that IBC-MBVD may provide a rate-distortion value for the first block that is better than other rate-distortion values for the first block and determine to encode the first block using IBC-MBVD based on the rate-distortion values. Video encoder 200 may signal a syntax element whose value is indicative of the IBC-MBVD in a bitstream. Video decoder 300 may parse the syntax element in the bitstream to determine to decode the first block using IBC-MBVD. For example, video decoder 300 may determine the value of the syntax element and the value of the syntax element may indicate to video decoder 300 to use IBC-MBVD for the first block.

Video encoder 200 or video decoder 300 may process a syntax element indicative of whether to use IBC-MBVD with fractional-pel offsets or to use IBC-MBVD with integer-pel offsets (1902). For example, video encoder 200 may perform encoding passes using fractional-pel offsets and using integer-pel offsets and determine whether to encode the first block using IBC-MBVD with fractional-pel offsets or using IBC-MBVD with integer-pel offsets based on resulting rate-distortion values. For example, video encoder 200 may select the type of offset based on the better rate-distortion value. Video encoder 200 may generate another syntax element whose value is indicative of whether the first block is encoded using IBC-MBVD with fractional-pel offsets or whether the first block is encoded using IBC-MBVD with integer-pel offsets. For example, the syntax element may be of a first value when the first block is encoded using IBC-MBVD with fractional-pel offsets and of a second, different value, when the first block is encoded using IBC-MBVD with integer-pel offsets. Video encoder 200 may signal the syntax element in the bitstream.

Video decoder 300 may parse the other syntax element when processing the other syntax element to determine to decode the first block using IBC-MBVD with fractional-pel offsets or to decode the first block using IBC-MBVD with integer-pel offsets. For example, video decoder 300 may determine the value of the other syntax element and the value of the other syntax element may indicate to video decoder 300 whether to use IBC-MBVD with fractional-pel offsets or to use IBC-MBVD with integer-pel offsets.

Video encoder 200 or video decoder 300 may code the first block based on a determination of whether to use IBC-MBVD with fractional-pel offsets or IBC-MBVD with integer-pel offsets (1904). For example, video encoder 200 may encode the first block using IBC-MBVD with fractional-pel offsets or video decoder 300 may decode the first block using IBC-MBVD with fractional-pel offsets, if the value of the syntax element indicates that the first block is encoded using IBC-MBVD with fractional-pel offsets.

In some examples, code includes encode, and video encoder 200 may signal the syntax element in a header applicable to the first block (e.g., a picture header), the syntax element having a value indicative of using IBC-MBVD with fractional-pel offsets. In some examples, code includes decode, and video decoder 300 may, as part of processing the syntax element, parse the syntax element in a header applicable to the first block (e.g., a picture header), the syntax element having a value indicative of using IBC-MBVD with fractional-pel offsets.

In some examples, video encoder 200 or video decoder 300 may determine that IBC regular merge mode is disabled for a second block of video data. Video encoder 200 or video decoder 300 may, based on a determination that IBC regular merge mode is disabled for the second block, not code (e.g., not signal by video encoder 200, not parse by video decoder 300) a syntax element indicating a maximum number of IBC merge candidates for the second block. Video encoder 200 or video decoder 300 may set a value of the syntax element to a default integer number. For example, other IBC merge modes and/or other modes may require a value of the syntax element. Video encoder 200 and video decoder 300 may save transmission bandwidth by not signaling/parsing the value of the syntax element and instead setting the value of the syntax element to the default integer number. In some examples, the default integer number is 6.

In some examples, video encoder 200 or video decoder 300 may determine that all IBC merge modes are disabled for a second block of video data. Video encoder 200 or video decoder 300 may, based on a determination that all IBC merge modes are disabled for the second block, not code (e.g., not signal by video encoder 200, not parse by video decoder 300) a syntax element indicating a maximum number of IBC merge candidates for the second block. Video encoder 200 or video decoder 300 may set a value of the syntax element to a default integer number. For example, other modes may require a value of the syntax element. Video encoder 200 and video decoder 300 may save transmission bandwidth by not signaling/parsing the value of the syntax element and instead setting the value of the syntax element to the default integer number. In some examples, the default integer number is 6.

In some examples, video encoder 200 or video decoder 300 may determine to code a second block of the video data using AMVR mode. Video encoder 200 or video decoder 300 may, based on determining to code the second block using the AMVR mode, apply a first CABAC context modeler to bins of a magnitude suffix of a horizontal component of a block vector difference for the second block and bins of a magnitude suffix of a vertical component of a block vector difference for the second block. Video encoder 200 or video decoder 300 may determine to code a third block of the video data using inter mode. Video encoder 200 or video decoder 300 may, based on determining to code the third block using the inter mode, apply a second CABAC context modeler to bins of a magnitude suffix of a horizontal component of a block vector difference for the third block and bins of a magnitude suffix of a vertical component of a block vector difference for the third block, wherein the first CABAC context modeler is different than the second CABAC context modeler.

In some examples, video encoder 200 or video decoder 300 may determine to apply fractional-pel interpolation to LMCS domain samples of a second block of the video data. In some examples, based on determining to apply fractional-pel interpolation to the LMCS domain samples, apply fractional-pel interpolation to the LMSC domain samples in an LMSC domain.

In some examples, video encoder 200 or video decoder 300 may determine to apply fractional-pel interpolation to LMCS domain samples of a second block of the video data. Video encoder 200 or video decoder 300 may, based on determining to apply fractional-pel interpolation to the LMCS domain samples, map the LMCS domain samples from an LMCS domain to a pixel domain to generate mapped samples. Video encoder 200 or video decoder 300 may apply fractional-pel interpolation to the mapped samples in the pixel domain to generate fractional-pel interpolated samples. Video encoder 200 or video decoder 300 may map the fractional-pel interpolated samples to the LMCS domain.

In some examples, video encoder 200 or video decoder 300 may determine that a fractional-pel block vector is supported for a second block of the video data. Video encoder 200 or video decoder 300 may, based on the fractional-pel block vector being supported for the second block, context code a first 5 most significant bins of each of a block vector difference horizontal component and a block vector difference vertical component for the second block. Video encoder 200 or video decoder 300 may determine that the fractional-pel block vector is not supported for a third block of the video data. Video encoder 200 or video decoder 300 may, based on the fractional-pel block vector not being supported for the third block, context code a first 3 most significant bins of each of a block vector difference horizontal component and a block vector difference vertical component for the third block.

In some examples, video encoder 200 or video decoder 300 may determine to use at least one of an IBC mode or an intra template matching (IntraTMP) mode to code a second block of the video data. Video encoder 200 or video decoder 300 may code the second block using the at least one of the IBC mode or the IntraTMP mode. Video encoder 200 or video decoder 300 may generate a template for LIC, wherein generating the template includes using a pre-defined first 2-tap bilinear filter for luma components of the second block and using a pre-defined second 2-tap bilinear filter for chroma components of the second block, wherein the first 2-tap bilinear filter is the same as the second 2-tap bilinear filter or different than the second 2-tap bilinear filter.

In some examples, video encoder 200 or video decoder 300 may determine to perform ARMC for IBC for a second block of the video data. Video encoder 200 or video decoder 300 may generate a reference template block for the second block wherein generating the reference template block includes using a pre-defined first 2-tap bilinear filter.

In some examples, video encoder 200 or video decoder 300 may determine offsets to AMVP candidates, wherein the offsets to the AMVP candidates include: for a horizontal one-dimension mode, AMVP candidate 0=(max (−W, −PosX)<<r, 0)+(Δx, 0), and AMVP candidate 1=(−PosX<<r, 0); and for a vertical one-dimension mode, AMVP candidate 0=(0, max (−H, −TopY)<<r)+(0, Ays), and AMVP candidate 1=(0, −TopY<<r), where (Δx, Δy)=(3<<(r−2), 3<<(r−2)) for quarter-pel precision and (Δx, Δy)=(1<<(r−1), 1<<(r−1)) for half-pel precision.

In some examples, video encoder 200 or video decoder 300 may determine to apply at least one of an IBC mode or an intra template matching (IntraTMP) mode to a second block of the video data. Video encoder 200 or video decoder 300 may apply the at least one of the IBC mode or the IntraTMP mode to the second block. Video encoder 200 or video decoder 300 may determine a minimal area of reference samples for the second block. Video encoder 200 or video decoder 300 may determine a fraction-pel BV to be valid based on all reference samples being within a valid search range of the at least one of the IBC mode or the IntraTMP mode. Video encoder 200 or video decoder 300 may code the second block based on the application of the at least one of the IBC mode or the IntraTMP mode, wherein the minimal area is defined as a width by a height (W×H) pointed to by a truncated version of the BV and wherein the truncated version of the BV is defined as ((BVx>>r)<<r, (BVy>>r)<<r), where r is the log 2-scale storage precision for the BV.

In some examples, video encoder 200 or video decoder 300 may determine to apply at least one of an IBC mode or an IntraTMP mode to a second block of the video data. Video encoder 200 or video decoder 300 may apply the at least one of the IBC mode or the IntraTMP mode to the second block. Video encoder 200 or video decoder 300 may determine a minimal area of reference samples for the second block. Video encoder 200 or video decoder 300 may determine a fraction-pel BV to be valid based on all reference samples being within a valid search range of the at least one of the IBC mode or the IntraTMP mode. Video encoder 200 or video decoder 300 may code the second block based on the application of the at least one of the IBC mode or the IntraTMP mode, wherein the minimal area includes a rectangular shape smaller than a width by a height (W×H) pointed to by a truncated version of the BV and wherein the truncated version of the BV is defined as ((BVx>>r)<<r, (BVy>>r)<<r), where r is the log 2-scale storage precision for the BV, and at least as large as a minimum width by a minimum height, wherein the minimal area is pointed to by (((BVx>>r)<<r)+Δx, ((BVy>>r)<<r)+Δy), where Δx=((W−Wmin)>>1) and Δy=((H−Hmin)>>1).

In some examples, video encoder 200 or video decoder 300 may determine to apply at least one of an IBC mode or an IntraTMP mode to a second block of the video data. Video encoder 200 or video decoder 300 may apply the at least one of the IBC mode or the IntraTMP mode to the second block. Video encoder 200 or video decoder 300 may determine a minimal area of reference samples for the second block. Video encoder 200 or video decoder 300 may determine a fraction-pel BV to be valid based on all reference samples being within a valid search range of the at least one of the IBC mode or the IntraTMP mode. Video encoder 200 or video decoder 300 may code the second block based on the application of the at least one of the IBC mode or the IntraTMP mode, wherein the minimal area is (W+(M−1))×(H+(N−1)) pointed to by (BVx−(M/2)+1, BVy−(N/2)+1), and wherein an overlapping area between the minimum area the valid search range is not empty.

In some examples, video encoder 200 or video decoder 300 may determine that there is at least one unavailable reference sample of a reference sample area for a second block of the video data. Video encoder 200 or video decoder 300 may, based on the at least one unavailable sample, determine to apply padding to the at least one unavailable reference sample, wherein padding includes at least one of horizontal padding or vertical padding. Video encoder 200 or video decoder 300 may apply the at least one of horizontal padding or vertical padding to the reference sample area, wherein applying the horizontal padding includes copying a nearest horizontal available sample in a valid search area of the reference sample area to a respective unavailable sample in a same horizontal row of samples as the respective unavailable sample, and wherein applying the vertical padding includes copying a nearest vertical available sample in the valid search area of the reference sample area to the respective unavailable sample in a same vertical row of samples as the respective unavailable sample, and wherein when both horizontal padding and vertical padding are applied, horizontal padding is applied prior to vertical padding. In some examples, all reference samples within a minimum area of reference samples are available.

In some examples, video encoder 200 or video decoder 300 may determine a minimal area of reference samples of a reference sample area for a second block of the video data. Video encoder 200 or video decoder 300 may determine a valid search range of the reference sample area. Video encoder 200 or video decoder 300 may apply at least one of horizontal padding or vertical padding to each sample within the valid search range that is outside the minimal area, wherein applying the horizontal padding includes copying a nearest horizontal available sample in a valid search area of the reference sample area to a respective unavailable sample in a same horizontal row of samples as the respective unavailable sample, and wherein applying the vertical padding includes copying a nearest vertical available sample in the valid search area of the reference sample area to the respective unavailable sample in a same vertical row of samples as the respective unavailable sample, and wherein when both horizontal padding and vertical padding are applied, horizontal padding is applied before vertical padding.

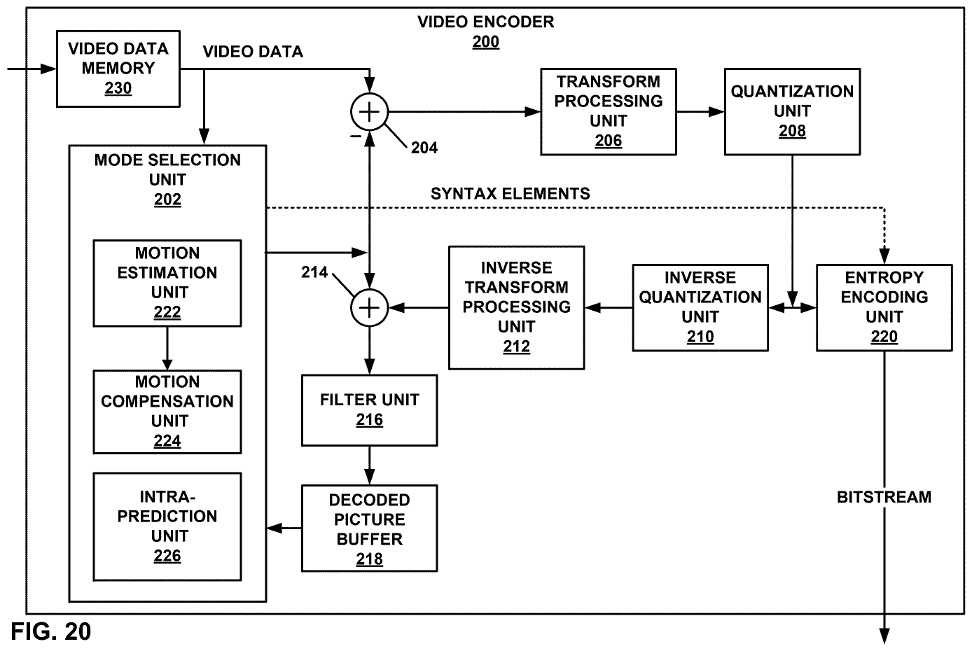

FIG. 20 is a block diagram illustrating an example video encoder 200 that may perform the techniques of this disclosure. FIG. 20 is provided for purposes of explanation and should not be considered limiting of the techniques as broadly exemplified and described in this disclosure. For purposes of explanation, this disclosure describes video encoder 200 according to the techniques of VVC and HEVC. However, the techniques of this disclosure may be performed by video encoding devices that are configured to other video coding standards and video coding formats, such as AV1 and successors to the AV1 video coding format.

In the example of FIG. 20, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. For instance, the units of video encoder 200 may be implemented as one or more circuits or logic elements as part of hardware circuitry, or as part of a processor, ASIC, or FPGA. Moreover, video encoder 200 may include additional or alternative processors or processing circuitry to perform these and other functions.

Video data memory 230 may store video data to be encoded by the components of video encoder 200. Video encoder 200 may receive the video data stored in video data memory 230 from, for example, video source 104 (FIG. 1). DPB 218 may act as a reference picture memory that stores reference video data for use in prediction of subsequent video data by video encoder 200. Video data memory 230 and DPB 218 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 20 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the instructions (e.g., object code) of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, a motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUS, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the MTT structure, QTBT structure. superblock structure, or the quad-tree structure described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

When operating according to the AV1 video coding format, motion estimation unit 222 and motion compensation unit 224 may be configured to encode coding blocks of video data (e.g., both luma and chroma coding blocks) using translational motion compensation, affine motion compensation, overlapped block motion compensation (OBMC), and/or compound inter-intra prediction.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

In some examples, intra-prediction unit 226 may perform the techniques of this disclosure with respect to IBC and/or IntraTMP, such as the techniques of FIG. 19. For example, intra-prediction unit 226 may determine to code a first block of the video data using intra block copy merge mode with block vector differences (IBC-MBVD). Intra-prediction unit 226 may process (e.g., generate) a syntax element indicative of whether to use IBC-MBVD with fractional-pel offsets or to use IBC-MBVD with integer-pel offsets. Intra-prediction unit 226 may code the first block based on a determination of whether to use IBC-MBVD with fractional-pel offsets or IBC-MBVD with integer-pel offsets.

When operating according to the AV1 video coding format, intra-prediction unit 226 may be configured to encode coding blocks of video data (e.g., both luma and chroma coding blocks) using directional intra prediction, non-directional intra prediction, recursive filter intra prediction, chroma-from-luma (CFL) prediction, intra block copy (IBC), and/or color palette mode. Mode selection unit 202 may include additional functional units to perform video prediction in accordance with other prediction modes.

Mode selection unit 202 provides the prediction block to residual generation unit 204. Residual generation unit 204 receives a raw, unencoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUS, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2NxnU, 2NxnD, nLx2N, and nRx2N for inter prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as some examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

When operating according to AV1, transform processing unit 206 may apply one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a horizontal/vertical transform combination that may include a discrete cosine transform (DCT), an asymmetric discrete sine transform (ADST), a flipped ADST (e.g., an ADST in reverse order), and an identity transform (IDTX). When using an identity transform, the transform is skipped in one of the vertical or horizontal directions. In some examples, transform processing may be skipped.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the transform coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

When operating according to AV1, filter unit 216 may perform one or more filter operations on reconstructed blocks. For example, filter unit 216 may perform deblocking operations to reduce blockiness artifacts along edges of CUs. In other examples, filter unit 216 may apply a constrained directional enhancement filter (CDEF), which may be applied after deblocking, and may include the application of non-separable, non-linear, low-pass directional filters based on estimated edge directions. Filter unit 216 may also include a loop restoration filter, which is applied after CDEF, and may include a separable symmetric normalized Wiener filter or a dual self-guided filter.

Video encoder 200 stores reconstructed blocks in DPB 218. For instance, in examples where operations of filter unit 216 are not performed, reconstruction unit 214 may store reconstructed blocks to DPB 218. In examples where operations of filter unit 216 are performed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream.

In accordance with AV1, entropy encoding unit 220 may be configured as a symbol-to-symbol adaptive multi-symbol arithmetic coder. A syntax element in AV1 includes an alphabet of N elements, and a context (e.g., probability model) includes a set of N probabilities. Entropy encoding unit 220 may store the probabilities as n-bit (e.g., 15-bit) cumulative distribution functions (CDFs). Entropy encoding unit 220 may perform recursive scaling, with an update factor based on the alphabet size, to update the contexts.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

Video encoder 200 represents an example of a device configured to encode video data including one or more memories configured to store the video data; and one or more processors implemented in circuitry and coupled to the one or more memories, the one or more processors being configured to: determine to code a first block of the video data using intra block copy merge mode with block vector differences (IBC-MBVD); process a syntax element indicative of whether to use IBC-MBVD with fractional-pel offsets or to use IBC-MBVD with integer-pel offsets; and code the first block based on a determination of whether to use IBC-MBVD with fractional-pel offsets or IBC-MBVD with integer-pel offsets.

Video encoder 200 represents an example of a device configured to encode video data including a memory configured to store video data, and one or more processing units implemented in circuitry and configured to determine to apply at least one of intra block copy (IBC) or intra template matching (IntraTMP); apply the at least one of IBC or IntraTMP; determine a minimal area of reference samples; determine a fraction-pel block vector (BV) to be valid based on all reference samples being within a valid search range of the at least one of IBC or IntraTMP; and encode the video data based on the application of the at least one of IBC or IntraTMP.

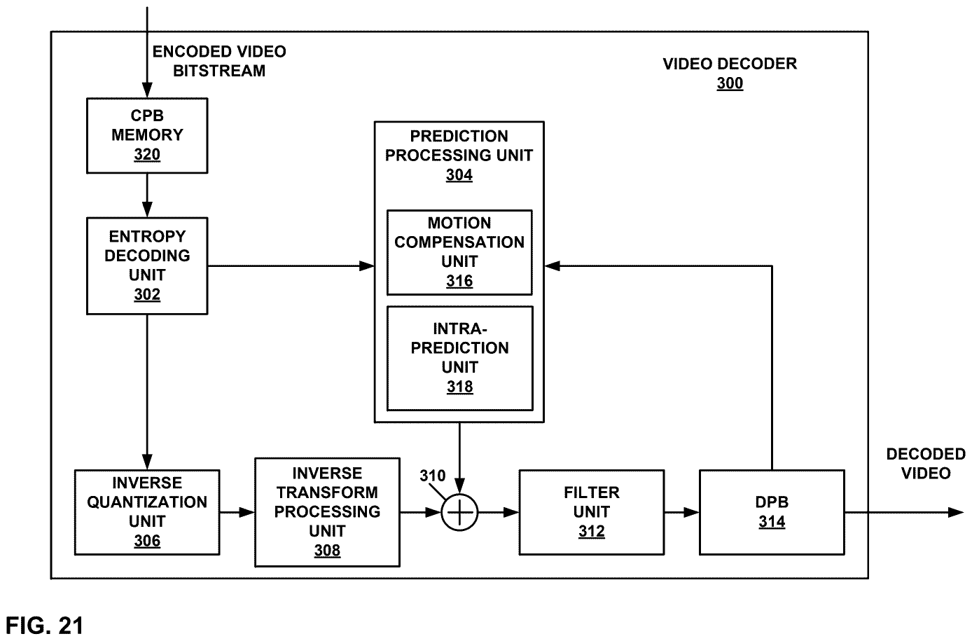

FIG. 21 is a block diagram illustrating an example video decoder 300 that may perform the techniques of this disclosure. FIG. 21 is provided for purposes of explanation and is not limiting on the techniques as broadly exemplified and described in this disclosure. For purposes of explanation, this disclosure describes video decoder 300 according to the techniques of VVC and HEVC. However, the techniques of this disclosure may be performed by video coding devices that are configured to other video coding standards.

In the example of FIG. 21, video decoder 300 includes coded picture buffer (CPB) memory 320, entropy decoding unit 302, prediction processing unit 304, inverse quantization unit 306, inverse transform processing unit 308, reconstruction unit 310, filter unit 312, and DPB 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. For instance, the units of video decoder 300 may be implemented as one or more circuits or logic elements as part of hardware circuitry, or as part of a processor, ASIC, or FPGA. Moreover, video decoder 300 may include additional or alternative processors or processing circuitry to perform these and other functions.

Prediction processing unit 304 includes motion compensation unit 316 and intra-prediction unit 318. Prediction processing unit 304 may include additional units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

When operating according to AV1, motion compensation unit 316 may be configured to decode coding blocks of video data (e.g., both luma and chroma coding blocks) using translational motion compensation, affine motion compensation, OBMC, and/or compound inter-intra prediction, as described above. Intra-prediction unit 318 may be configured to decode coding blocks of video data (e.g., both luma and chroma coding blocks) using directional intra prediction, non-directional intra prediction, recursive filter intra prediction, CFL, IBC, and/or color palette mode, as described above.

In some examples, intra-prediction unit 318 may perform the techniques of this disclosure with respect to IBC and/or IntraTMP, such as the techniques of FIG. 19. For example, intra-prediction unit 318 may determine to code a first block of the video data using intra block copy merge mode with block vector differences (IBC-MBVD). Intra-prediction unit 318 may process (e.g., parse) a syntax element indicative of whether to use IBC-MBVD with fractional-pel offsets or to use IBC-MBVD with integer-pel offsets. Intra-prediction unit 318 may code the first block based on a determination of whether to use IBC-MBVD with fractional-pel offsets or IBC-MBVD with integer-pel offsets.

CPB memory 320 may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 generally stores decoded pictures, which video decoder 300 may output and/or use as reference video data when decoding subsequent data or pictures of the encoded video bitstream. CPB memory 320 and DPB 314 may be formed by any of a variety of memory devices, such as DRAM, including SDRAM, MRAM, RRAM, or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 21 are illustrated to assist with understanding the operations performed by video decoder 300. The units may be implemented as fixed-function circuits, programmable circuits, or a combination thereof. Similar to FIG. 20, fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the transform coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 20).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 20). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. For instance, in examples where operations of filter unit 312 are not performed, reconstruction unit 310 may store reconstructed blocks to DPB 314. In examples where operations of filter unit 312 are performed, filter unit 312 may store the filtered reconstructed blocks to DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures (e.g., decoded video) from DPB 314 for subsequent presentation on a display device, such as display device 118 of FIG. 1.

In this manner, video decoder 300 represents an example of a video decoding device including one or more memories configured to store the video data; and one or more processors implemented in circuitry and coupled to the one or more memories, the one or more processors being configured to: determine to code a first block of the video data using intra block copy merge mode with block vector differences (IBC-MBVD); process a syntax element indicative of whether to use IBC-MBVD with fractional-pel offsets or to use IBC-MBVD with integer-pel offsets; and code the first block based on a determination of whether to use IBC-MBVD with fractional-pel offsets or IBC-MBVD with integer-pel offsets.

Video decoder 300 also represents an example of a video decoding device including a memory configured to store video data, and one or more processing units implemented in circuitry and configured to determine to apply at least one of intra block copy (IBC) or intra template matching (IntraTMP); apply the at least one of IBC or IntraTMP; determine a minimal area of reference samples; determine a fraction-pel block vector (BV) to be valid based on all reference samples being within a valid search range of the at least one of IBC or IntraTMP; and decode the video data based on the application of the at least one of IBC or IntraTMP.

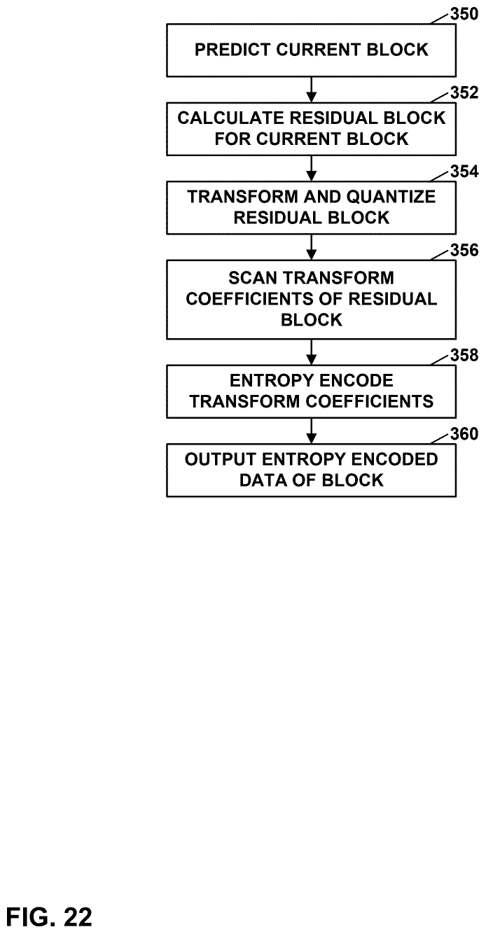

FIG. 22 is a flowchart illustrating an example method for encoding a current block in accordance with the techniques of this disclosure. The current block may be or include a current CU. Although described with respect to video encoder 200 (FIGS. 1 and 19), it should be understood that other devices may be configured to perform a method similar to that of FIG. 22.

In this example, video encoder 200 initially predicts the current block (350). For example, video encoder 200 may form a prediction block for the current block. Video encoder 200 may then calculate a residual block for the current block (352). To calculate the residual block, video encoder 200 may calculate a difference between the original, unencoded block and the prediction block for the current block. In some examples, as part of forming the prediction block and/or calculating the residual block, video encoder 200 may perform the IBC and/or IntraTMP techniques of this disclosure. For example, video encoder 200 may perform the techniques of FIG. 19, including using fractional-pel offsets for IBC-MBVD.

Video encoder 200 may then transform the residual block and quantize transform coefficients of the residual block (354). Next, video encoder 200 may scan the quantized transform coefficients of the residual block (356). During the scan, or following the scan, video encoder 200 may entropy encode the transform coefficients (358). For example, video encoder 200 may encode the transform coefficients using CAVLC or CABAC. Video encoder 200 may then output the entropy encoded data of the block (360).

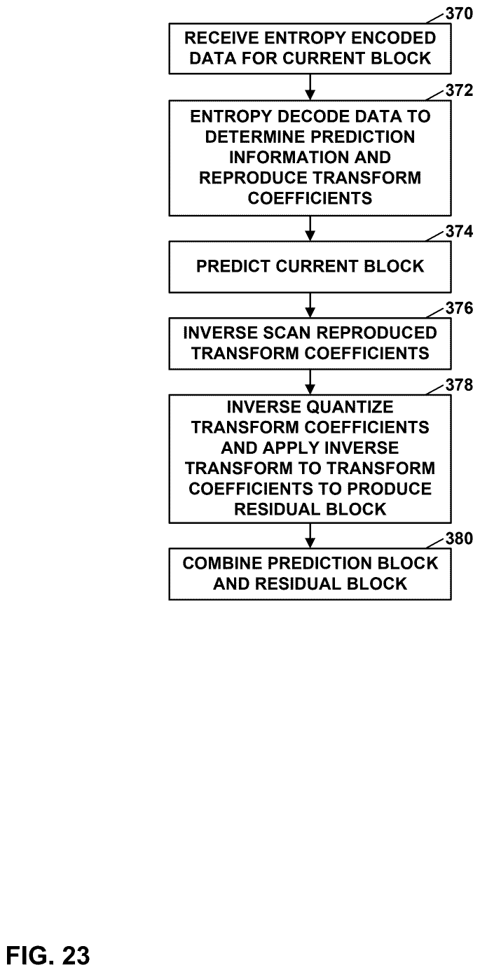

FIG. 23 is a flowchart illustrating an example method for decoding a current block of video data in accordance with the techniques of this disclosure. The current block may be or include a current CU. Although described with respect to video decoder 300 (FIGS. 1 and 21, it should be understood that other devices may be configured to perform a method similar to that of FIG. 23.

Video decoder 300 may receive entropy encoded data for the current block, such as entropy encoded prediction information and entropy encoded data for transform coefficients of a residual block corresponding to the current block (370). Video decoder 300 may entropy decode the entropy encoded data to determine prediction information for the current block and to reproduce transform coefficients of the residual block (372). Video decoder 300 may predict the current block (374), e.g., using an intra- or inter-prediction mode as indicated by the prediction information for the current block, to calculate a prediction block for the current block. In some examples, as part of predicting the current block, video decoder 300 may perform the IBC and/or IntraTMP techniques of this disclosure. For example, video decoder 300 may perform the techniques of FIG. 19, including using fractional-pel offsets for IBC-MBVD.

Video decoder 300 may then inverse scan the reproduced transform coefficients (376), to create a block of quantized transform coefficients. Video decoder 300 may then inverse quantize the transform coefficients and apply an inverse transform to the transform coefficients to produce a residual block (378). Video decoder 300 may ultimately decode the current block by combining the prediction block and the residual block (380).

The following numbered clauses illustrate one or more aspects of the devices and techniques described in this disclosure.

Clause 1A. A method of coding video data, the method comprising: determining to apply at least one of intra block copy (IBC) or intra template matching (IntraTMP); applying the at least one of IBC or IntraTMP; determining a minimal area of reference samples; determining a fraction-pel block vector (BV) to be valid based on all reference samples being within a valid search range of the at least one of IBC or

IntraTMP; and coding the video data based on the application of the at least one of IBC or IntraTMP.

Clause 2A. The method of clause 1A, wherein the minimal area is defined as a width by a height (W×H) pointed to by a truncated version of the BV and wherein the truncated version of the BV is defined as ((BVx>>r)<<r, (BVy>>r)<<r), where r is the log 2-scale storage precision for the BV.

Clause 3A. The method of clause 1A, wherein the minimal area comprises a rectangular shape smaller than a width by a height (W×H) pointed to by a truncated version of the BV and wherein the truncated version of the BV is defined as ((BVx>>r)<<r, (BVy>>r)<<r), where r is the log 2-scale storage precision for the BV, and at least as large as a minimum width by a minimum height.

Clause 4A. The method of clause 1A, wherein the minimal area is pointed to by (((BVx>>r)<<r)+Δx, ((BVy>>r)<<r)+Δy), where Δx=((W−Wmin)>>1) and Δy=((H−Hmin)>>1).

Clause 5A. The method of clause 1A, wherein the minimal area is (W+(M−1))×(H+(N−1)) pointed to by (BVx−(M/2)+1, BVy−(N/2)+1), and wherein an overlapping area between the minimum area the valid search range is not empty.

Clause 6A. The method of any of clauses 1A-5A, further comprising: applying horizontal padding; and applying vertical padding.

Clause 6.1A. The method of clause 6A, wherein applying horizontal padding and applying vertical padding are unconditional.

Clause 7A. The method of clause 6A, wherein horizontal padding is applied to unavailable samples.

Clause 8A. The method of clause 6A or 7A, wherein the horizontal padding is applied prior to vertical padding and vertical padding is applied to unavailable samples that have not been horizontally padded.

Clause 9A. The method of any of clauses 6A-8A, further comprising applying a 4-tap interpolation filter.

Clause 10A. The method of any of clauses 6A-9A, wherein at least one of the horizontal padding or the vertical padding is fraction-pel based.

Clause 11A. The method of clause 10A, wherein the at least one of IBC or IntraTMP is fraction-pel based.

Clause 12A. The method of clause 11A, wherein the at least one of IBC or IntraTMP comprises an IBC merge mode with block vector differences.

Clause 13A. The method of clause 12A, further comprising signaling or parsing a flag indicative of switching between integer-pel offsets and fractional-pel offsets.

Clause 14A. The method of clause 11A or 12A, further comprising right shifting an integer-pel offset by a number of bits to implement a fractional-pel offset.

Clause 15A. The method of any of clauses 11A-14A, further comprising applying a 6-tap switchable filter to interpolate the video data.

Clause 16A. The method of any of clauses 11A-14A, further comprising applying a default filter to interpolate the video data.

Clause 17A. The method of any of clauses 11A-14A, further comprising signaling or parsing a flag indicative of whether to apply a 6-tap switchable filter or a default filter to interpolate the video data.

Clause 18A. The method of clause 17A, wherein whether to apply a 6-tap switchable filter or a default filter to interpolate the video data is further based on an adaptive motion vector resolution (AMVR) mode being a half-pel mode and at least a BV component pointing to a half-pel phase on a current frame.

Clause 18.1A. The method of clause 10A, further comprising: determining whether to apply a default luma interpolation filter or an alternative default filter; and applying the default luma interpolation filter or the alternative default filter, wherein the alternative default filter comprises fewer taps than the default luma interpolation filter.

Clause 18.2A. The method of clause 18.1A, further comprising scaling filter coefficients of the alternative default filter.

Claus 18.3A. The method of clause 18.1A or clause 18.2A, further comprising right shifting a fractional portion of the BV prior to applying the alternative default filter.

Clause 19A. The method of any of clauses 11A-18.3A, wherein a context-adaptive binary arithmetic coding (CABAC) context modeler for an adaptive motion vector resolution (AMVR) mode is different than a CABAC context modeler for an inter mode.

Clause 20A. The method of any of clauses 11A-18.3A, further comprising initializing an initial state of a context-adaptive binary arithmetic coding (CABAC) context modeler for an adaptive motion vector resolution (AMVR) mode for an I-slice using an initial state of the CABAC context modeler for the AMVR mode for a B-slice or a P-slice.

Clause 21A. The method of any of clauses 11A-20A, further comprising applying overlapped block motion compensation (OBMC) to the video data.

Clause 22A. The method of clause 21A, further comprising signaling or parsing a flag indictive of applying OBMC to the video data.

Clause 23A. The method of clause 21A, further comprising: determining that a neighboring block of a current block of the video data is not coded using IBC-combined inter-intra prediction (CIIP) mode; and applying OBMC to the video data using at least one of a BV for the neighboring block or a motion vector for the neighboring block.

Clause 24A. The method of clause 21A, further comprising: determining that a neighboring block of a current block of the video data is coded using inter mode, IBC mode, or IntraTMP mode; determining that the neighboring block is not coded by IBC-combined inter-intra prediction (CIIP) or Inter-CIIP mode; and applying OBMC to the video data using at least one of a BV for the neighboring block or a motion vector for the neighboring block.

Clause 25A. The method of any of clauses 21A-24A, further comprising: using an LIC flag of neighboring block of a current block to generate OBMC hypotheses prediction samples of OBMC hypotheses; and blending the OBMC hypotheses prediction samples with current block prediction samples.

Clause 26A. The method of any of clauses 11A-25A, further comprising applying fractional-pel interpolation using luma mapping with chroma scaling (LMCS) domain samples.

Clause 27A. The method of any of clauses 11A-25A, further comprising: mapping luma mapping with chroma scaling (LMCS) domain samples into a pixel domain; applying fractional-pel interpolation to samples in the pixel domain; and mapping the fractional-pel interpolated samples to the LMCS domain.

Clause 28A. The method of any of clauses 1A-25A, further comprising template matching comprising searching from integer-pel precision down to a pre-defined fractional-pel precision.

Clause 29A. The method of any of clauses 1A-26A, wherein a luma interpolation filter used to generate a local illumination compensation (LIC) template is pre-defined.

Clause 30A. The method of any of clauses 1A-29A, wherein offsets to AMVP candidates comprise: for a horizontal one-dimension mode, AMVP candidate 0=(max (−W, −PosX)<<r, 0)+(Δx, 0), and AMVP candidate 1=(−PosX<<r, 0), for a vertical one-dimension mode, AMVP candidate 0=(0, max (−H, −TopY)<<r)+(0, Ays), and AMVP candidate 1=(0, −TopY<<r), where (Δx, Δy)=(1<<(r−2), 1<<(r−2)) for quarter-pel precision and (Δx, Δy)=(1<<(r−1), 1<<(r−1)) for half-pel precision.

Clause 31A. The method of any of clauses 1A-30A, further comprising: determining that dual I-tree is enabled; determining that IBC is enabled; based on both dual I-tree being enabled and IBC being enabled, determining a chroma BV candidate list from BVs from a collocated luma area; pruning repeated BVs from the chroma BV candidate list; and applying ARMC to sort the chroma BV candidate list based on template matching.

Clause 32A. The method of clause 31A, further comprising applying a merge candidate construction process to add more chroma BV candidates to the chroma BV candidate list.

Clause 33A. The method of clause 31A or 32A, further comprising signaling or parsing an index indicative of a selected candidate from the chroma BV candidate list.

Clause 34A. The method of any of clauses 1A-33A, wherein coding comprises encoding.

Clause 35A. A device for coding video data, the device comprising one or more means for performing the method of any of clauses 1A-34A.

Clause 36A. The device of clause 35A, wherein the one or more means comprise one or more processors implemented in circuitry.

Clause 37A. The device of any of clauses 35A and 36A, further comprising a memory to store the video data.

Clause 38A. The device of any of clauses 35A-37A, further comprising a display configured to display decoded video data.

Clause 39A. The device of any of clauses 35A-38A, wherein the device comprises one or more of a camera, a computer, a mobile device, a broadcast receiver device, or a set-top box.

Clause 40A. The device of any of clauses 35A-39A, wherein the device comprises a video decoder.

Clause 41A. The device of any of clauses 35A-40A, wherein the device comprises a video encoder.

Clause 42A. A computer-readable storage medium having stored thereon instructions that, when executed, cause one or more processors to perform the method of any of clauses 1A-34A

Clause 1B. A method of coding video data, the method comprising: determining to code a first block of the video data using intra block copy merge mode with block vector differences (IBC-MBVD); processing a syntax element indicative of whether to use IBC-MBVD with fractional-pel offsets or to use IBC-MBVD with integer-pel offsets; and coding the first block based on a determination of whether to use IBC-MBVD with fractional-pel offsets or IBC-MBVD with integer-pel offsets.

Clause 2B. The method of clause 1B, wherein coding comprises encoding, and wherein the method further comprises signaling the syntax element in a header applicable to the first block, the syntax element having a value indicative of using IBC-MBVD with fractional-pel offsets.

Clause 3B. The method of claim 1B, wherein coding comprises decoding, and wherein processing the syntax element comprises parsing the syntax element in a header applicable to the first block, the syntax element having a value indicative of using IBC-MBVD with fractional-pel offsets.

Clause 4B. The method of any of clauses 1B-3B, wherein coding comprises decoding, and wherein the method further comprises: determining that intra block copy (IBC) regular merge mode is disabled for a second block of video data; based on determining that IBC regular merge mode is disabled for the second block, not coding a syntax element indicating a maximum number of IBC merge candidates for the second block; and setting a value of the syntax element to a default integer number.

Clause 5B. The method of clause 4B, wherein the default integer number is 6.

Clause 6B. The method of any of clauses 1B-5B, wherein coding comprises decoding, and wherein the method further comprises: determining that all IBC merge modes are disabled for a second block of video data; based on determining that all IBC merge modes are disabled for the second block, not coding a syntax element indicating a maximum number of IBC merge candidates for the second block; and setting a value of the syntax element to a default integer number.

Clause 7B. The method of clause 6B, wherein the default integer number is 6.

Clause 8B. The method of any of clauses 1B-7B, further comprising: determining to code a second block of the video data using adaptive motion vector resolution (AMVR) mode; based on determining to code the second block using the AMVR mode, applying a first context-adaptive binary arithmetic coding (CABAC) context modeler to bins of a magnitude suffix of a horizontal component of a block vector difference for the second block and bins of a magnitude suffix of a vertical component of a block vector difference for the second block; determining to code a third block of the video data using inter mode; and based on determining to code the third block using the inter mode, applying a second CABAC context modeler to bins of a magnitude suffix of a horizontal component of a block vector difference for the third block and bins of a magnitude suffix of a vertical component of a block vector difference for the third block, wherein the first CABAC context modeler is different than the second CABAC context modeler.

Clause 9B. The method of any of clauses 1B-8B, further comprising: determining to apply fractional-pel interpolation to luma mapping with chroma scaling (LMCS) domain samples of a second block of the video data; and based on determining to apply fractional-pel interpolation to the LMCS domain samples, applying fractional-pel interpolation to the LMSC domain samples in an LMSC domain.

Clause 10B. The method of any of clauses 1B-8B, further comprising: determining to apply fractional-pel interpolation to luma mapping with chroma scaling (LMCS) domain samples of a second block of the video data; based on determining to apply fractional-pel interpolation to the LMCS domain samples, mapping the LMCS domain samples from an LMCS domain to a pixel domain to generate mapped samples; applying fractional-pel interpolation to the mapped samples in the pixel domain to generate fractional-pel interpolated samples; and mapping the fractional-pel interpolated samples to the LMCS domain.

Clause 11B. The method of any of clauses 1B-10B, further comprising: determining that a fractional-pel block vector is supported for a second block of the video data; based on the fractional-pel block vector being supported for the second block, context coding a first 5 most significant bins of each of a block vector difference horizontal component and a block vector difference vertical component for the second block; determining that the fractional-pel block vector is not supported for a third block of the video data; and based on the fractional-pel block vector not being supported for the third block, context coding a first 3 most significant bins of each of a block vector difference horizontal component and a block vector difference vertical component for the third block.

Clause 12B. The method of any of clauses 1B-11B, further comprising: determining to use at least one of an intra block copy (IBC) mode or an intra template matching (IntraTMP) mode to code a second block of the video data; coding the second block using the at least one of the IBC mode or the IntraTMP mode; and generating a template for local illumination compensation (LIC), wherein generating the template comprises using a pre-defined first 2-tap bilinear filter for luma components of the second block and using a pre-defined second 2-tap bilinear filter for chroma components of the second block, wherein the first 2-tap bilinear filter is the same as the second 2-tap bilinear filter or different than the second 2-tap bilinear filter.

Clause 13B. The method of any of clauses 1B-12B, further comprising: determining to perform adaptive reordering of merge candidates (ARMC) for intra block copy (IBC) for a second block of the video data; and generating a reference template block for the second block wherein generating the reference template block comprises using a pre-defined first 2-tap bilinear filter.

Clause 14B. The method of any of clauses 1B-13B, further comprising: determining offsets to advanced motion vector prediction (AMVP) candidates, wherein the offsets to the AMVP candidates comprise: for a horizontal one-dimension mode, AMVP candidate 0=(max (−W, −PosX)<<r, 0)+(Δx, 0), and AMVP candidate 1=(−PosX<<r, 0); and for a vertical one-dimension mode, AMVP candidate 0=(0, max (−H, −TopY)<<r)+(0, Ays), and AMVP candidate 1=(0, −TopY<<r), where (Δx, Δy)=(3<<(r−2), 3<<(r−2)) for quarter-pel precision and (Δx, Δy)=(1<<(r−1), 1<<(r−1)) for half-pel precision.

Clause 15B. The method of any of clauses 1B-14B, further comprising: determining to apply at least one of an intra block copy (IBC) mode or an intra template matching (IntraTMP) mode to a second block of the video data; applying the at least one of the IBC mode or the IntraTMP mode to the second block; determining a minimal area of reference samples for the second block; determining a fraction-pel block vector (BV) to be valid based on all reference samples being within a valid search range of the at least one of the IBC mode or the IntraTMP mode; and coding the second block based on the application of the at least one of the IBC mode or the IntraTMP mode, wherein the minimal area is defined as a width by a height (W×H) pointed to by a truncated version of the BV and wherein the truncated version of the BV is defined as ((BVx>>r)<<r, (BVy>>r)<<r), where r is a log 2-scale storage precision for the BV.

Clause 16B. The method of any of clauses 1B-14B, further comprising: determining to apply at least one of an intra block copy (IBC) mode or an intra template matching (IntraTMP) mode to a second block of the video data; applying the at least one of the IBC mode or the IntraTMP mode to the second block; determining a minimal area of reference samples for the second block; determining a fraction-pel block vector (BV) to be valid based on all reference samples being within a valid search range of the at least one of the IBC mode or the IntraTMP mode; and coding the second block based on the application of the at least one of the IBC mode or the IntraTMP mode, wherein the minimal area comprises a rectangular shape smaller than a width by a height (W×H) pointed to by a truncated version of the BV and wherein the truncated version of the BV is defined as ((BVx>>r)<<r, (BVy>>r)<<r), where r is a log 2-scale storage precision for the BV, and at least as large as a minimum width by a minimum height, wherein the minimal area is pointed to by (((BVx>>r)<<r)+Δx, ((BVy>>r)<<r)+Δy), where Δx=((W−Wmin)>>1) and Δy=((H-Hmin)>>1).

Clause 17B. The method of any of clauses 1B-14B, further comprising: determining to apply at least one of an intra block copy (IBC) mode or an intra template matching (IntraTMP) mode to a second block of the video data; applying the at least one of the IBC mode or the IntraTMP mode to the second block; determining a minimal area of reference samples for the second block; determining a fraction-pel block vector (BV) to be valid based on all reference samples being within a valid search range of the at least one of the IBC mode or the IntraTMP mode; and coding the second block based on the application of the at least one of the IBC mode or the IntraTMP mode, wherein the minimal area is (W+(M−1))×(H+(N−1)) pointed to by (BVx−(M/2)+1, BVy−(N/2)+1), and wherein an overlapping area between the minimum area the valid search range is not empty.

Clause 18B. The method of any of clauses 1B-17B, further comprising: determining that there is at least one unavailable reference sample of a reference sample area for a second block of the video data; based on the at least one unavailable sample, determining to apply padding to the at least one unavailable reference sample, wherein padding comprises at least one of horizontal padding or vertical padding; and applying the at least one of horizontal padding or vertical padding to the reference sample area, wherein applying the horizontal padding comprises copying a nearest horizontal available sample in a valid search area of the reference sample area to a respective unavailable sample in a same horizontal row of samples as the respective unavailable sample, and wherein applying the vertical padding comprises copying a nearest vertical available sample in the valid search area of the reference sample area to the respective unavailable sample in a same vertical row of samples as the respective unavailable sample, and wherein when both horizontal padding and vertical padding are applied, horizontal padding is applied prior to vertical padding.

Clause 19B. The method of clause 18B, wherein all reference samples within a minimum area of reference samples are available.

Clause 20B. The method of any of clauses 1B-17B, further comprising: determining a minimal area of reference samples of a reference sample area for a second block of the video data; determining a valid search range of the reference sample area; and applying at least one of horizontal padding or vertical padding to each sample within the valid search range that is outside the minimal area, wherein applying the horizontal padding comprises copying a nearest horizontal available sample in a valid search area of the reference sample area to a respective unavailable sample in a same horizontal row of samples as the respective unavailable sample, and wherein applying the vertical padding comprises copying a nearest vertical available sample in the valid search area of the reference sample area to the respective unavailable sample in a same vertical row of samples as the respective unavailable sample, and wherein when both horizontal padding and vertical padding are applied, horizontal padding is applied before vertical padding.

Clause 21B. A device for coding video data, the device comprising: one or more memories configured to store the video data; and one or more processors implemented in circuitry and coupled to the one or more memories, the one or more processors being configured to: determine to code a first block of the video data using intra block copy merge mode with block vector differences (IBC-MBVD); process a syntax element indicative of whether to use IBC-MBVD with fractional-pel offsets or to use IBC-MBVD with integer-pel offsets; and code the first block based on a determination of whether to use IBC-MBVD with fractional-pel offsets or IBC-MBVD with integer-pel offsets.

Clause 22B. The device of clause 21B, wherein code comprises encode, and wherein the one or more processors are further configured to signal the syntax element in a header applicable to the first block, the syntax element having a value indicative of using IBC-MBVD with fractional-pel offsets.

Clause 23B. The device of clause 21B, wherein coding comprises decoding, and wherein determining as part of processing the syntax element, the one or more processors are configured to parse the syntax element in a header applicable to the first block, the syntax element having a value indicative of using IBC-MBVD with fractional-pel offsets.

Clause 24B. The device of any of clauses 21B-23B, wherein code comprises decode, and wherein the one or more processors are further configured to: determine that intra block copy (IBC) regular merge mode is disabled for a second block of video data; based on determining that IBC regular merge mode is disabled for the second block, not code a syntax element indicating a maximum number of IBC merge candidates for the second block; and set a value of the syntax element to a default integer number.

Clause 25B. The device of clause 24B, wherein the default integer number is 6.

Clause 26B. The device of any of clauses 21B-25B, wherein the one or more processors are further configured to: determine that all intra block copy (IBC) merge modes are disabled for a second block of video data; based on determining that all IBC merge modes are disabled for the second block, not code a syntax element indicating a maximum number of IBC merge candidates for the second block; and set a value of the syntax element to a default integer number.

Clause 27B. The device of clause 26B, wherein the default integer number is 6.

Clause 28B. The device of any of clause 21B-27B, wherein code comprises decode, and wherein the one or more processors are further configured to: determine to code a second block of the video data using adaptive motion vector resolution (AMVR) mode; based on determining to code the second block using the AMVR mode, apply a first context-adaptive binary arithmetic coding (CABAC) context modeler to bins of a magnitude suffix of a horizontal component of a block vector difference for the second block and bins of a magnitude suffix of a vertical component of a block vector difference for the second block; determine to code a third block of the video data using inter mode; and based on determining to code the third block using the inter mode, apply a second CABAC context modeler to bins of a magnitude suffix of a horizontal component of a block vector difference for the third block and bins of a magnitude suffix of a vertical component of a block vector difference for the third block, wherein the first CABAC context modeler is different than the second CABAC context modeler.

Clause 29B. The device of any of clauses 21B-28B, wherein the one or more processors are further configured to: determine to apply fractional-pel interpolation to luma mapping with chroma scaling (LMCS) domain samples of a second block of the video data; and based on determining to apply fractional-pel interpolation to the LMCS domain samples, apply fractional-pel interpolation to the LMSC domain samples in an LMSC domain.

Clause 30B. The device of any of clauses 21B-28B, wherein the one or more processors are further configured to: determine to apply fractional-pel interpolation to luma mapping with chroma scaling (LMCS) domain samples of a second block of the video data; based on determining to apply fractional-pel interpolation to the LMCS domain samples, map the LMCS domain samples from an LMCS domain to a pixel domain to generate mapped samples; apply fractional-pel interpolation to the mapped samples in the pixel domain to generate fractional-pel interpolated samples; and map the fractional-pel interpolated samples to the LMCS domain.

Clause 31B. The device of any of clauses 21B-30B, wherein the one or more processors are further configured to: determine that a fractional-pel block vector is supported for a second block of the video data; based on the fractional-pel block vector being supported for the second block, context code a first 5 most significant bins of each of a block vector difference horizontal component and a block vector difference vertical component for the second block; determine that the fractional-pel block vector is not supported for a third block of the video data; and based on the fractional-pel block vector not being supported for the third block, context code a first 3 most significant bins of each of a block vector difference horizontal component and a block vector difference vertical component for the third block.

Clause 32B. The device of clause 21B-31B, wherein the one or more processors are further configured to: determine to use at least one of an intra block copy (IBC) mode or an intra template matching (IntraTMP) mode to code a second block of the video data; code the second block using the at least one of the IBC mode or the IntraTMP mode; and generate a template for local illumination compensation (LIC), wherein generating the template comprises using a pre-defined first 2-tap bilinear filter for luma components of the second block and using a pre-defined second 2-tap bilinear filter for chroma components of the second block, wherein the first 2-tap bilinear filter is the same as the second 2-tap bilinear filter or different than the second 2-tap bilinear filter.

Clause 33B. The device of any of clauses 21B-32B, wherein the one or more processors are further configured to: determine to perform adaptive reordering of merge candidates (ARMC) for intra block copy (IBC) for a second block of the video data; and generate a reference template block for the second block wherein generating the reference template block comprises using a pre-defined first 2-tap bilinear filter.

Clause 34B. The device of any of clauses 21B-33B, wherein the one or more processors are further configured to: determine offsets to advanced motion vector prediction (AMVP) candidates, wherein the offsets to the AMVP candidates comprise: for a horizontal one-dimension mode, AMVP candidate 0=(max (−W, −PosX)<<r, 0)+(Δx, 0), and AMVP candidate 1=(−PosX<<r, 0); and for a vertical one-dimension mode, AMVP candidate 0=(0, max (−H, −TopY)<<r)+(0, Ays), and AMVP candidate 1=(0, −TopY<<r), where (Δx, Δy)=(3<<(r−2), 3<<(r−2)) for quarter-pel precision and (Δx, Δy)=(1<<(r−1), 1<<(r−1)) for half-pel precision.

Clause 35B. The device of any of clause 21B-34B, wherein the one or more processors are further configured to: determine to apply at least one of an intra block copy (IBC) mode or an intra template matching (IntraTMP) mode to a second block of the video data; apply the at least one of the IBC mode or the IntraTMP mode to the second block; determine a minimal area of reference samples for the second block; determine a fraction-pel block vector (BV) to be valid based on all reference samples being within a valid search range of the at least one of the IBC mode or the IntraTMP mode; and code the second block based on the application of the at least one of the IBC mode or the IntraTMP mode, wherein the minimal area is defined as a width by a height (W×H) pointed to by a truncated version of the BV and wherein the truncated version of the BV is defined as ((BVx>>r)<<r, (BVy>>r)<<r), where r is a log 2-scale storage precision for the BV.

Clause 36B. The device of any of clause 21B-34B, wherein the one or more processors are further configured to: determine to apply at least one of an intra block copy (IBC) mode or an intra template matching (IntraTMP) mode to a second block of the video data; apply the at least one of the IBC mode or the IntraTMP mode to the second block; determine a minimal area of reference samples for the second block; determine a fraction-pel block vector (BV) to be valid based on all reference samples being within a valid search range of the at least one of the IBC mode or the IntraTMP mode; and code the second block based on the application of the at least one of the IBC mode or the IntraTMP mode, wherein the minimal area comprises a rectangular shape smaller than a width by a height (W×H) pointed to by a truncated version of the BV and wherein the truncated version of the BV is defined as ((BVx>>r)<<r, (BVy>>r)<<r), where r is a log 2-scale storage precision for the BV, and at least as large as a minimum width by a minimum height, wherein the minimal area is pointed to by (((BVx>>r)<<r)+Δx, ((BVy>>r)<<r)+Δy), where Δx=((W−Wmin)>>1) and Δy=((H−Hmin)>>1).

Clause 37B. The device of any of clauses 21B-34B, wherein the one or more processors are further configured to: determine to apply at least one of an intra block copy (IBC) mode or an intra template matching (IntraTMP) mode to a second block of the video data; apply the at least one of the IBC mode or the IntraTMP mode to the second block; determine a minimal area of reference samples for the second block; determine a fraction-pel block vector (BV) to be valid based on all reference samples being within a valid search range of the at least one of the IBC mode or the IntraTMP mode; and code the second block based on the application of the at least one of the IBC mode or the IntraTMP mode, wherein the minimal area is (W+(M−1))×(H+(N−1)) pointed to by (BVx (M/2)+1, BVy−(N/2)+1), and wherein an overlapping area between the minimum area the valid search range is not empty.

Clause 38B. The device of any of clause 21B-37B, wherein the one or more processors are further configured to: determine that there is at least one unavailable reference sample of a reference sample area for a second block of the video data; based on the at least one unavailable sample, determine to apply padding to the at least one unavailable reference sample, wherein padding comprises at least one of horizontal padding or vertical padding; and apply the at least one of horizontal padding or vertical padding to the reference sample area, wherein applying the horizontal padding comprises copying a nearest horizontal available sample in a valid search area of the reference sample area to a respective unavailable sample in a same horizontal row of samples as the respective unavailable sample, and wherein applying the vertical padding comprises copying a nearest vertical available sample in the valid search area of the reference sample area to the respective unavailable sample in a same vertical row of samples as the respective unavailable sample, and wherein when both horizontal padding and vertical padding are applied, horizontal padding is applied prior to vertical padding.

Clause 39B. The device of clause 38B, wherein all reference samples within a minimum area of reference samples are available.

Clause 40B. The device of any of clauses 21B-37B, wherein the one or more processors are further configured to: determine a minimal area of reference samples of a reference sample area for a second block of the video data; determine a valid search range of the reference sample area; and apply at least one of horizontal padding or vertical padding to each sample within the valid search range that is outside the minimal area, wherein applying the horizontal padding comprises copying a nearest horizontal available sample in a valid search area of the reference sample area to a respective unavailable sample in a same horizontal row of samples as the respective unavailable sample, and wherein applying the vertical padding comprises copying a nearest vertical available sample in the valid search area of the reference sample area to the respective unavailable sample in a same vertical row of samples as the respective unavailable sample, and wherein when both horizontal padding and vertical padding are applied, horizontal padding is applied before vertical padding.

Clause 41B. The device of any of clauses 21B-40B, further comprising at least one of a camera to capture the video data or a display to display the video data.

Clause 42B. Computer-readable storage media having stored thereon instructions that, when executed, cause one or more processors to: determine to code a first block of video data using intra block copy merge mode with block vector differences (IBC-MBVD); process a syntax element indicative of whether to use IBC-MBVD with fractional-pel offsets or to use IBC-MBVD with integer-pel offsets; and code the first block based on a determination of whether to use IBC-MBVD with fractional-pel offsets or IBC-MBVD with integer-pel offsets.

Clause 43B. A device for coding video data, the device comprising: means for determining to code a first block of the video data using intra block copy merge mode with block vector differences (IBC-MBVD); means for determining to code the first block using IBC-MBVD with fractional-pel offsets; and means for coding the first block based on the fractional-pel offsets based on determining to code the first block using IBC-MBVD with fractional-pel offsets.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of coding video data, the method comprising:
determining to code a first block of the video data using intra block copy merge mode with block vector differences (IBC-MBVD);
processing a syntax element indicative of whether to use IBC-MBVD with fractional-pel offsets or to use IBC-MBVD with integer-pel offsets;
coding the first block based on a determination of whether to use IBC-MBVD with fractional-pel offsets or IBC-MBVD with integer-pel offsets;
determining to code a second block of the video data using adaptive motion vector resolution (AMVR) mode;
based on determining to code the second block using the AMVR mode, applying a first context-adaptive binary arithmetic coding (CABAC) context modeler to bins of a magnitude suffix of a horizontal component of a block vector difference for the second block and bins of a magnitude suffix of a vertical component of a block vector difference for the second block;
determining to code a third block of the video data using inter mode; and
based on determining to code the third block using the inter mode, applying a second CABAC context modeler to bins of a magnitude suffix of a horizontal component of a block vector difference for the third block and bins of a magnitude suffix of a vertical component of a block vector difference for the third block, wherein the first CABAC context modeler is different than the second CABAC context modeler.

2. The method of claim 1, further comprising:
determining that a fractional-pel block vector is supported for a fourth block of the video data;
based on the fractional-pel block vector being supported for the fourth block, context coding a first 5 most significant bins of each of a block vector difference horizontal component and a block vector difference vertical component for the fourth block;
determining that the fractional-pel block vector is not supported for a fifth block of the video data; and
based on the fractional-pel block vector not being supported for the fifth block, context coding a first 3 most significant bins of each of a block vector difference horizontal component and a block vector difference vertical component for the fifth block.

3. The method of claim 1, further comprising:
determining to apply at least one of an intra block copy (IBC) mode or an intra template matching (IntraTMP) mode to a fourth block of the video data;
applying the at least one of the IBC mode or the IntraTMP mode to the fourth block;
determining a minimal area of reference samples for the fourth block;
determining a fraction-pel block vector (BV) to be valid based on all reference samples being within a valid search range of the at least one of the IBC mode or the IntraTMP mode; and
coding the fourth block based on the application of the at least one of the IBC mode or the IntraTMP mode,
wherein the minimal area is defined as a width by a height (W×H) pointed to by a truncated version of the BV and wherein the truncated version of the BV is defined as ((BVx>>r)<<r, (BVy>>r)<<r), where r is a log 2-scale storage precision for the BV.

4. The method of claim 1, further comprising:
determining to apply at least one of an intra block copy (IBC) mode or an intra template matching (IntraTMP) mode to a fourth block of the video data;
applying the at least one of the IBC mode or the IntraTMP mode to the fourth block;
determining a minimal area of reference samples for the fourth block;
determining a fraction-pel block vector (BV) to be valid based on all reference samples being within a valid search range of the at least one of the IBC mode or the IntraTMP mode; and
coding the fourth block based on the application of the at least one of the IBC mode or the IntraTMP mode,
wherein the minimal area comprises a rectangular shape smaller than a width by a height (W×H) pointed to by a truncated version of the BV and wherein the truncated version of the BV is defined as ((BVx>>r)<<r, (BVy>>r)<<r), where r is a log 2-scale storage precision for the BV, and at least as large as a minimum width by a minimum height, wherein the minimal area is pointed to by (((BVx>>r)<<r)+Δx, ((BVy>>r)<<r)+Δy), where Δx=((W−Wmin)>>1) and Δy=((H−Hmin)>>1).

5. The method of claim 1, further comprising:
determining to apply at least one of an intra block copy (IBC) mode or an intra template matching (IntraTMP) mode to a fourth block of the video data;
applying the at least one of the IBC mode or the IntraTMP mode to the fourth block;
determining a minimal area of reference samples for the fourth block;
determining a fraction-pel block vector (BV) to be valid based on all reference samples being within a valid search range of the at least one of the IBC mode or the IntraTMP mode; and
coding the fourth block based on the application of the at least one of the IBC mode or the IntraTMP mode, wherein the minimal area is (W+(M−1))×(H+(N−1)) pointed to by (BVx−(M/2)+1, BVy−(N/2)+1), and wherein an overlapping area between the minimum area the valid search range is not empty.

6. The method of claim 1, further comprising:
determining to use at least one of an intra block copy (IBC) mode or an intra template matching (IntraTMP) mode to code a fourth block of the video data;
coding the fourth block using the at least one of the IBC mode or the IntraTMP mode; and
generating a template for local illumination compensation (LIC), wherein generating the template comprises using a pre-defined first 2-tap bilinear filter for luma components of the second block and using a pre-defined second 2-tap bilinear filter for chroma components of the second block, wherein the first 2-tap bilinear filter is the same as the second 2-tap bilinear filter or different than the second 2-tap bilinear filter.

7. The method of claim 1, wherein coding comprises decoding.

8. The method of claim 1, wherein coding comprises encoding.

9. A device for coding video data, the device comprising:
one or more memories configured to store the video data; and
one or more processors implemented in circuitry and coupled to the one or more memories, the one or more processors being configured to:
determine to code a first block of the video data using intra block copy merge mode with block vector differences (IBC-MBVD);
process a syntax element indicative of whether to use IBC-MBVD with fractional-pel offsets or to use IBC-MBVD with integer-pel offsets;
code the first block based on a determination of whether to use IBC-MBVD with fractional-pel offsets or IBC-MBVD with integer-pel offsets;
determine to code a second block of the video data using adaptive motion vector resolution (AMVR) mode;
based on determining to code the second block using the AMVR mode, apply a first context-adaptive binary arithmetic coding (CABAC) context modeler to bins of a magnitude suffix of a horizontal component of a block vector difference for the second block and bins of a magnitude suffix of a vertical component of a block vector difference for the second block; determine to code a third block of the video data using inter mode; and
based on determining to code the third block using the inter mode, apply a second CABAC context modeler to bins of a magnitude suffix of a horizontal component of a block vector difference for the third block and bins of a magnitude suffix of a vertical component of a block vector difference for the third block, wherein the first CABAC context modeler is different than the second CABAC context modeler.

10. The device of claim 9, wherein the one or more processors are further configured to:
determine that a fractional-pel block vector is supported for a fourth block of the video data;
based on the fractional-pel block vector being supported for the fourth block, context code a first 5 most significant bins of each of a block vector difference horizontal component and a block vector difference vertical component for the fourth block;
determine that the fractional-pel block vector is not supported for a fifth block of the video data; and
based on the fractional-pel block vector not being supported for the fifth block, context code a first 3 most significant bins of each of a block vector difference horizontal component and a block vector difference vertical component for the fifth block.

11. The device of claim 9, wherein the one or more processors are further configured to:
determine to apply at least one of an intra block copy (IBC) mode or an intra template matching (IntraTMP) mode to a fourth block of the video data;
apply the at least one of the IBC mode or the IntraTMP mode to the fourth block;
determine a minimal area of reference samples for the fourth block;
determine a fraction-pel block vector (BV) to be valid based on all reference samples being within a valid search range of the at least one of the IBC mode or the IntraTMP mode; and
code the fourth block based on the application of the at least one of the IBC mode or the IntraTMP mode,
wherein the minimal area is defined as a width by a height (W×H) pointed to by a truncated version of the BV and wherein the truncated version of the BV is defined as ((BVx>>r)<<r, (BVy>>r)<<r), where r is a log 2-scale storage precision for the BV.

12. The device of claim 9, wherein the one or more processors are further configured to:
determine to apply at least one of an intra block copy (IBC) mode or an intra template matching (IntraTMP) mode to a fourth block of the video data;
apply the at least one of the IBC mode or the IntraTMP mode to the fourth block;
determine a minimal area of reference samples for the fourth block;
determine a fraction-pel block vector (BV) to be valid based on all reference samples being within a valid search range of the at least one of the IBC mode or the IntraTMP mode; and
code the fourth block based on the application of the at least one of the IBC mode or the IntraTMP mode,
wherein the minimal area comprises a rectangular shape smaller than a width by a height (W×H) pointed to by a truncated version of the BV and wherein the truncated version of the BV is defined as ((BVx>>r)<<r, (BVy>>r)<<r), where r is a log 2-scale storage precision for the BV, and at least as large as a minimum width by a minimum height, wherein the minimal area is pointed to by (((BVx>>r)<<r)+Δx, ((BVy>>r)<<r)+Δy), where Δx=((W−Wmin)>>1) and Δy=((H−Hmin)>>1).

13. The device of claim 9, wherein the one or more processors are further configured to:
determine to apply at least one of an intra block copy (IBC) mode or an intra template matching (IntraTMP) mode to a fourth block of the video data;
apply the at least one of the IBC mode or the IntraTMP mode to the fourth block;
determine a minimal area of reference samples for the fourth block;
determine a fraction-pel block vector (BV) to be valid based on all reference samples being within a valid search range of the at least one of the IBC mode or the IntraTMP mode; and
code the fourth block based on the application of the at least one of the IBC mode or the IntraTMP mode, wherein the minimal area is (W+(M−1))×(H+(N−1)) pointed to by (BVx−(M/2)+1, BVy−(N/2)+1), and wherein an overlapping area between the minimum area the valid search range is not empty.

14. The device of claim 9, wherein the one or more processors are further configured to:
determine to use at least one of an intra block copy (IBC) mode or an intra template matching (IntraTMP) mode to code a fourth block of the video data;
code the fourth block using the at least one of the IBC mode or the IntraTMP mode; and
generate a template for local illumination compensation (LIC), wherein generating the template comprises using a pre-defined first 2-tap bilinear filter for luma components of the second block and using a pre-defined second 2-tap bilinear filter for chroma components of the second block, wherein the first 2-tap bilinear filter is the same as the second 2-tap bilinear filter or different than the second 2-tap bilinear filter.

15. The device of claim 9, wherein the device comprises a video decoder.

16. The device of claim 15, further comprising a display configured to display decoded video data.

17. The device of claim 9, wherein the device comprises a video encoder.

18. The device of claim 17, further comprising a camera configured to capture the video data.

19. Non-transitory, computer-readable storage media having stored thereon instructions that, when executed, cause one or more processors to:
determine to code a first block of video data using intra block copy merge mode with block vector differences (IBC-MBVD);
process a syntax element indicative of whether to use IBC-MBVD with fractional-pel offsets or to use IBC-MBVD with integer-pel offsets;
code the first block based on a determination of whether to use IBC-MBVD with fractional-pel offsets or IBC-MBVD with integer-pel offsets;
determining to code a second block of the video data using adaptive motion vector resolution (AMVR) mode;
based on determining to code the second block using the AMVR mode, applying a first context-adaptive binary arithmetic coding (CABAC) context modeler to bins of a magnitude suffix of a horizontal component of a block vector difference for the second block and bins of a magnitude suffix of a vertical component of a block vector difference for the second block;
determining to code a third block of the video data using inter mode; and
based on determining to code the third block using the inter mode, applying a second CABAC context modeler to bins of a magnitude suffix of a horizontal component of a block vector difference for the third block and bins of a magnitude suffix of a vertical component of a block vector difference for the third block, wherein the first CABAC context modeler is different than the second CABAC context modeler.

20. The non-transitory, computer-readable storage media of claim 19, wherein the instructions further cause the one or more processors to:
determine that a fractional-pel block vector is supported for a fourth block of the video data;
based on the fractional-pel block vector being supported for the fourth block, context code a first 5 most significant bins of each of a block vector difference horizontal component and a block vector difference vertical component for the fourth block;
determine that the fractional-pel block vector is not supported for a fifth block of the video data; and
based on the fractional-pel block vector not being supported for the fifth block, context code a first 3 most significant bins of each of a block vector difference horizontal component and a block vector difference vertical component for the fifth block.
